(19) United States
(12) Patent Application Publication
(10) Pub. No.: US 2018/0190966 A1
(43) Pub. Date: Jul. 5, 2018

(54) ELECTRICAL COMPONENTS FOR REDUCING EFFECTS FROM FLUID EXPOSURE AND VOLTAGE BIAS

(71) Applicant: Black & Decker, Inc., Newark, DE (US)

(72) Inventors: William Rigdon, Baltimore, MD (US); Daniel J. White, Middle River, MD (US); Matthew J. Velderman, Baltimore, MD (US); Andrew E. Seman, Pylesville, MD (US); Paul Becke, Stewartstown, PA (US); Andrew J. Yates, Baltimore, MD (US)

(21) Appl. No.: 15/860,404

(22) Filed: Jan. 2, 2018

Related U.S. Application Data
(60) Provisional application No. 62/441,519, filed on Jan. 2, 2017.

(51) Int. Cl. H01M 2/32; H01M 2/20; H01M 2/10

(52) U.S. Cl. CPC H01M 2/32; H01M 2220/30; H01M 2/1022; H01M 2/204

(57) ABSTRACT

In one general aspect, a device can include a housing and an electrical component disposed within the housing. At least a portion of the electrical component can include an active-passive material. The active-passive material can have a passivation range spanning a target bias voltage range of the device.

### RELATED APPLICATION

This application claims priority to and the benefit of U.S. Provisional Application No. 62/441,519, filed Jan. 2, 2017, entitled, “Electrical Components for Reducing Effects from Fluid Exposure and Voltage Bias”, which is incorporated herein by reference in its entirety.

### TECHNICAL FIELD

This description relates to electrical components that are configured to reduce the effects from fluid exposure and voltage bias.

### BACKGROUND

Electronic devices can include materials configured for behaviors primarily focused on performance of the product and manufacturability. These materials within these electronic devices (and components thereof), however, when exposed to a fluid and when biased to a voltage, can be degraded and/or fail in an undesirable fashion.

### SUMMARY

In one general aspect, a device can include a housing and an electrical component disposed within the housing. At least a portion of the electrical component can include an active-passive material. The active-passive material can have a passivation range spanning a target bias voltage range of the device.

### BRIEF DESCRIPTION OF THE DRAWINGS

FIG. 1 illustrates an electrical component included in an electrical device.

FIGS. 2A through 2E are example diagrams that illustrate passivation, corrosion, and immunity regions of materials.

FIG. 3 is a diagram that illustrates potential versus log corrosion rate or current density for a metal that can be included in an electrical component.

FIG. 4 illustrates four different metals that have varying passivation behaviors.

FIGS. 5 and 6 illustrate battery packs that can include an electrical component.

FIGS. 7 and 8 illustrate minimum and maximum voltages for example implementations of a battery pack.

FIGS. 9A and 9B are diagrams that illustrate passivation curves for steel under oxidizing conditions.

FIGS. 10A through 10C illustrate various examples of protective layer growth in aqueous conditions.

FIG. 11 is a diagram that illustrates oxidation rates.

FIG. 12 is a diagram that illustrates activation energies with and without a catalyst.

FIG. 13 illustrates metals that can be used for increasing activation energies for electrolysis reactions.

FIGS. 14 and 15 illustrate comparisons of electrolysis cells.

FIG. 16 is a diagram that illustrates heat generation.

FIG. 17A illustrates an example test system.

FIG. 17B illustrates energy data measured using the system shown in FIG. 17A.

FIG. 18 illustrates an electrolysis cell.

FIG. 19 is a diagram that illustrates a battery pack that includes wire bonding.

### DETAILED DESCRIPTION

Electronic devices such as power tools, batteries and battery packs, laptops, motors and/or power supplies rely on materials selected for behaviors primarily focused on performance of the product and manufacturability. For example, the battery industry often uses steel or plated steel for the connections between the cells. In motors, the fine pitch connectors have a voltage bias between each connector, but the connector material can be selected based on its electrical current carrying characteristics and mechanical performance (crimping). Alternating current (AC) to direct current (DC) power supplies can include many potential voltage differences or biased components within the electrical circuitry and select terminals based off electronic conductivity, and manufacturability.

These materials within these electronic devices (and components thereof), however, when exposed to a fluid (e.g., water) and when biased to a voltage (e.g., a DC voltage via a charger, an AC voltage), can fail in an undesirable fashion. In particular, in electronic applications where a voltage bias exists, there is potential for corrosion and other undesirable electrochemical (e.g., electrolysis) reactions when exposed to conductive fluid (e.g., water with dissolved ions). This effect is exacerbated when the voltage bias is greater and there is a higher concentration of electrolyte (for example, a salt dissolved in the water). Seawater or saltwater equivalents can be used to define acceptable behavior when metals under bias are subjected to this condition or other similar electrolytes. These electrolytes are defined as being near neutral pH (e.g., pH of approximately 4-10) with high concentrations of dissolved ion content (≲1M).

Some adverse effects of known materials can include degradation of device life from corrosion of components, added resistance from poor electrical contact or change in material properties, added heat from electrical resistance or undesired reactions, thermal runaway of components including battery, fire, caustic liquid formation, heat/pressure generation, explosion, formation of combustible gas mix thru electrolysis (e.g., H₂ and O₂), formation of toxic gas (e.g., chlorine, gases that are harmful to breathe, gases that can cause deleterious health including death or cancer), and so forth. For example, electrical devices can be exposed to a fluid including ions that can form an electrolyte between biased (e.g., DC biased) electrical components resulting in fire and explosion. This problem is not specific to batteries or power tools but can be a common problem in products that are electrically powered across a variety of applications and industries.

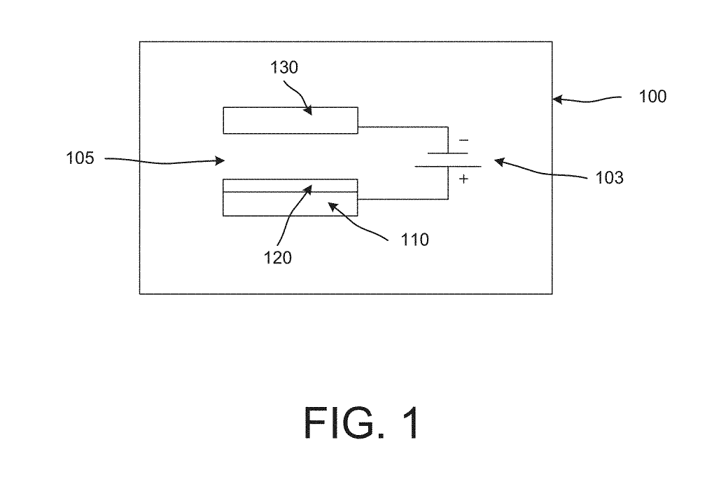

FIG. 1 illustrates an electrical component 110 included in an electrical device 100 that can be made of one or more materials configured (e.g., selected) to avoid undesirable failures when under a voltage bias relative to a potential (represented by element 103) of another component 130 (e.g., opposing electrode, opposite terminal) within the electrical device 100. For example, the electrical component 110 and methods for configuration described herein can be advantageous over known methods and materials for preventing fire, explosion, etc. and for increasing life and reliability of electronic devices with a voltage bias in the presence of a fluid (e.g., electrolyte or water with dissolved ions) (e.g., fluid 105).

The selection of material for the electrical component 110, and methods of configuration, described herein, for use in the electrical device 110, generally include at least one or more of the following characteristics:

(1) An active-passive type material (including metals and their alloys)

(2) A passivation range spanning a target bias voltage range

(3) A low energy of formation for corrosion products

(4) An electrolysis reaction inhibitor

At least one or more of the characteristics above can be included in, or used to configure, a material for inclusion in the electrical device 100 to eliminate undesirable release of heat, byproducts, failure, and so forth. Specifically, the characteristics above can be included in, or used to configure a material of the electrical component 110 that will be resistant to fire, explosions, degradation or performance, etc. even if a fluid (e.g., water) infiltrates the electrical device 100 while under voltage bias. The fire, explosions, degradation or performance, etc. can occur in response to, for example, heat when the fluid infiltrates the electrical device 100 while under voltage bias.

As a specific example, the electrical component 110 can be configured to, for example, minimize electrochemical reaction effects in biased components when exposed to fluid (e.g., water with ions). These criteria can be broadly applied to many examples. The electrical component 110 can be, or can include, for example, brass, bronze, silver, and/or similar alloys in an application of 20 volt bias condition with neutral pH saltwater (e.g. such as that experienced in battery pack).

The electrical component 110, and configuration methods thereof, can be advantageous over products (e.g. battery packs) that include elements to mitigate, for example, saltwater effects by taking primarily an extrinsic approach to the problem. Specifically, the electrical component 110, and configuration methods thereof, can be advantageous over methods and apparatus (e.g., industry standard methods of assembly and materials) to address catastrophic or reliability failures in water including, for example, glues, tapes, insulators, geometry (e.g., increased distances between voltages), dielectrics, greases, surface treatments, coatings, and so forth. The electrical component 110, and configuration methods thereof, can also be advantageous over methods and apparatus including the addition of dielectric adhesives, non-conductive insert between connected components, non-wetting (hydrophobic) treatments, package sealing sealed to prevent water intrusion, spacing of connectors (cells in pack) further apart, defining geometry to increase electrolyte path, avoiding use of low impedance cells (that may discharge too quickly in case of external short such as an aqueous based discharge mechanism), avoiding use of high voltage circuits, and so forth.

The problem of prior solutions was not previously fully appreciated and the general assumption was that undesirable failure was due primarily to the conductivity through water (e.g. Joule heating). This is a metal independent issue and a result of the electrolyte conductivity, not the metal's electrochemical or chemical reactivity. According to the present disclosure, the electrical component 100, in contrast, is configured based on an improved comprehension of electrochemical mechanisms including the effects from electrolysis and corrosion reactions. The electrical component 100 is configured based on an understanding of metal surface passivation and the role of metal reaction inhibiting behavior. The electrical component 100 is configured based on the rate of governing half-reactions at anode and cathode, which contribute to conductivity through an aqueous medium or fluid (e.g., saltwater) and generation of heat. Applying these factors to the electrical component 100 (e.g., metal (materials)) selection process has resulted in significant improvements over currently employed techniques.

Stated differently, current practices commonly use materials that are not especially resistant to electrochemical reactions (i.e. corrosion and electrolysis) under exposure to saltwater. Though it is common to use superficial practices that attempt to address the problem, understanding the root causes of the issue (which has not previously been comprehended) guides more appropriate selection of, for example, the electrical component 110 (e.g., a metal connector). For instance, there are currently issues with battery fires and explosions that result from the selection of metals used in their electrical circuitry and their housing materials. These failures have been identified for many years in the industry, but have only been somewhat resolved using superficial practices or result of empirical causality.

Advances in power electronics and new battery technology have led to an increase in DC voltage bias and high power electrical and/or new cordless products that were not previously possible. These high power devices are by design more susceptible to degradation mechanisms or failure from infiltration of aqueous fluids (e.g., water with ions). The corrosion and electrochemical reaction of such components is not commonly studied at such extreme conditions (i.e. far from equilibrium). Often times, reference data does not exist to predict how electrical connectors (e.g., metals) will perform or behave in these conditions. Selection practices outlined in this document attempt to guide this selection in order to minimize electrochemical effects. This effect can be validated with electrical calorimeter test described later to measure electrical energy dissipated through aqueous fluids and resultant generation of heat.

Basing the selection of the electrical component 110 instead on properties such as the varying electrochemical reactivity of different metals can have drastic positive effects on the performance, the heat generation, the safety, and/or the reliability of the electrical component 110. In other words, the properties intrinsic to the electrical component 110 also have a significant effect.

For example, many of the components (e.g., battery pack straps, terminals, conductors) use steel to connect cells together. Steel is particularly poor in its electrochemical reaction resistance to saltwater under bias. Similar issues exist for other common components such as aluminum (large free energy of oxide formation), nickel and copper (good electrolysis catalysts). Other issues with these metals can also exist (e.g., low passivation breakdown potential, no passivation, fast corrosion rate, and preference for chlorine gas formation). By staying within current design criteria for electrical components (e.g., conductivity, cost, strength, and solderability) the electrical component 110 can be configured to meet the desired minimized electrochemical reactivity criteria.

The electrical component 110, and methods of configuration of the electrical components 110, can have advantages including at least reduction or minimization of heat generation, protection of product integrity (e.g., electrical device 100), reduction or limitation of toxic gases, reduce toxic chemical formation, reduction or limitation of combustible products, mitigation of water caused failure, reduction or minimization of shorting of electrical connectors, lessening of effects from electrochemically unstable conditions, addressing of long felt need in the industry, and so forth. In some implementations, the reaction products can generate heat that does not exceed a threshold value determined, by a plastic melting point, a flash point, an electrolyte decomposition, or any critical material or product value associated with the electrical component 110 (e.g., a housing around the electrical component). The relationship can be roughly represented as follows: Heat Accumulated×Specific Heat<Critical Temperature Rise of Electrical Component.

Implementations of the present disclosure include one or more of the following features. The electrical component 110 can have corrosion resistance through stable passivation film formation. The electrical component 110 can have slow reaction rates and minimize heat generated. The electrical component 110 can have passivation film stable to voltages that span a connector high voltage and a nearest low voltage (e.g. difference of 20 volts). The electrical component 110 can have accelerated local corrosion. The electrical component 110 can cause electrical interruption or disconnect.

The electrical component 110 can corrode with a low energy of formation (ΔG) for byproducts (less heat) (e.g. Zinc). The electrical component 110 can have a water channel to direct electrolyte contact in case of exposure. The electrical component 110 can have a low current exchange density. The electrical component 110 can have relatively ineffective (e.g., bad) catalyst to slow electrolysis half-reactions (i.e. reaction inhibitor). The electrical component 110 can have slow corrosion kinetics. The electrical component 110 can minimize galvanic junction with connectors or plating of unalterable metals (e.g. conductor, battery terminal metal to strap metal has minimum ΔV to cause galvanic corrosion). The electrical component 110 can have relatively high conductivity. The electrical component 110 can minimize resistive heating inefficiencies (ideal for electrical connections). The electrical component 110 can have desirable cost, availability, machinability, weldability, solderability, mechanical properties, and so forth. The electrical component 110 can have geometry (e.g. surface area, spacing, etc.) configured for desirable behavior, coatings, counter-acting measures, and so forth.

The electrical component 110 can be configured to conduct electrical current. The electrical component 110 can include a metal that is workable for processing, manufacturing, and assembly of equipment. The electrical component 110 can have ideal strength, elasticity, and thermal coefficient of expansion. In other words, the electrical component 110 can have desirable mechanical properties. The electrical component 110 can include a metal that can be coupled to (e.g., weldable to, joinable to) existing components for simple integration into circuits (e.g. soldering connections should be possible). The electrical component 110 can include a metal that is affordable and/or commercially available so products can be bought/sold for a reasonable price (e.g., in some implementations, gold may be a cost prohibitive solution).

As shown in FIG. 1, the electrical component 110 includes a protective layer 120 (e.g., a passivation layer, a protective passivation layer, passivation film). The electrical component 110 can be an active-passive type alloy. The protective layer 120 of the electric component can provide corrosion resistance and/or can reduce heat generation (within pH range of, for example, an aqueous electrolyte). Although illustrated as being disposed on only one side of the electrical component 110, The protective layer 120 can be disposed on more than one side (e.g., on two sides, on more than two sides) of the electrical component 110.

In some implementations, when the electrical component 110 is, for example, a connector and is exposed to a fluid such as water, the electrical component 110, or a portion thereof, can change from an active state to a passive state. Changing quickly from the active state to the passive state can be advantageous, in some implementations. Formation of the protective layer 120 (which can be stable) can be critical to limiting electrochemical reaction rates. The protective layer 120 can be chemically bonded to (e.g., chemically formed on) the electrical component 110. A protective layer 120 may be formed in production of part or during infiltration of fluid between biased electrical connectors.

The electrical component 110 can be made of a metal that is not in equilibrium with the ambient environment, and can have a passive state on its surface which allows the electrical component 110 to be more useful in the electrical device 100. The protective layer 120 can inhibit (e.g., prevent) corrosion not only in aggressive chemical mediums but also in fluids (e.g., the moist atmosphere of the earth, fresh water). An active metal material (e.g., lithium and sodium metals) is one which undergoes uninhibited corrosion, and may not have a stable passive state. The electrical component should transition from the active to the passive state. Though most metals used in engineering metals form a thin passive surface film in air (≲100 nm), the state of these surfaces under voltage bias is more strictly defined in the following document. The stability of passive films in air is different from that of passive films in aqueous environments under voltage bias.

The electrical component 110 can be configured to undergo passivation in response to an applied bias. The electrical component 110 can configured to undergo anodic metal passivation in aqueous fluids above a biased voltage potential (e.g., passivation potential energy, Epp, also known as Flade potential). In such implementations, the anodic current of metal dissolution can decrease.

The protective layer 120 can be relatively thin. The protective layer 120 can be a nanometer-thin film (e.g., oxide film) is formed on the active metal anode. The protective layer 120 (e.g., an oxide film) can have a thickness that increases in response to increasing anodic potentials. The protective layer 120 can have a passivation current in the passive state that is controlled by the dissolution rate of the passive layer 120, which can be mostly independent of potential in the range of passivation. The electrical component 110 can have significantly lower corrosion current in the passive region than the active region, though this corrosion current can vary depending on the composition of the electrical component 110. In some implementations, a relatively low corrosion current through the electrical component 110 can be desirable because it can decrease (e.g., minimize) resistive heating, heat from corrosion and electrochemical products, and overall heat generated (e.g., minimize heat from dissipation of battery).

At least some examples of corrosion-resistant materials that can be included in the electrical component 110 can include, for example, copper alloys of the brass and bronze family. This can include, for example, copper alloyed with zinc, tin beryllium, silicon, silver, lead, cobalt, and phosphor, which can have good corrosion resistance when subjected to, for example, salt water conditions. Copper alloys of the brass families C200, C300, and C400 as well as bronze family C500 and C600 can have desirable performance in corrosion resistance while also providing sufficient conductivity, as well as other desirable manufacturing qualities. Copper beryllium of the C170 family can also have desirable corrosion resistance performance (in all cases, 0 can indicate any value from 0-9). Silver and silver alloys can also have favorable corrosion resistance performance. As a specific example, the electrical component 110 can be a material such as C50710, which can have, for example, between 1.7-2.3 atomic %, 0.15 atomic % P, 0.10-0.40 atomic % Ni, with the remainder being Cu. This material can be particularly valuable as the electrical component 110 given that this material satisfies the various criteria described herein.

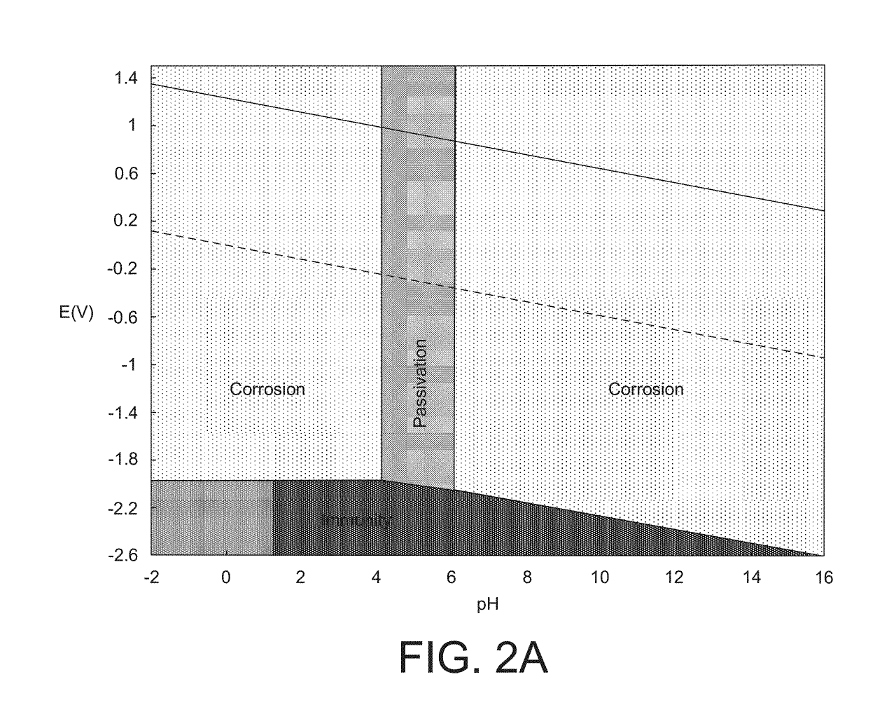

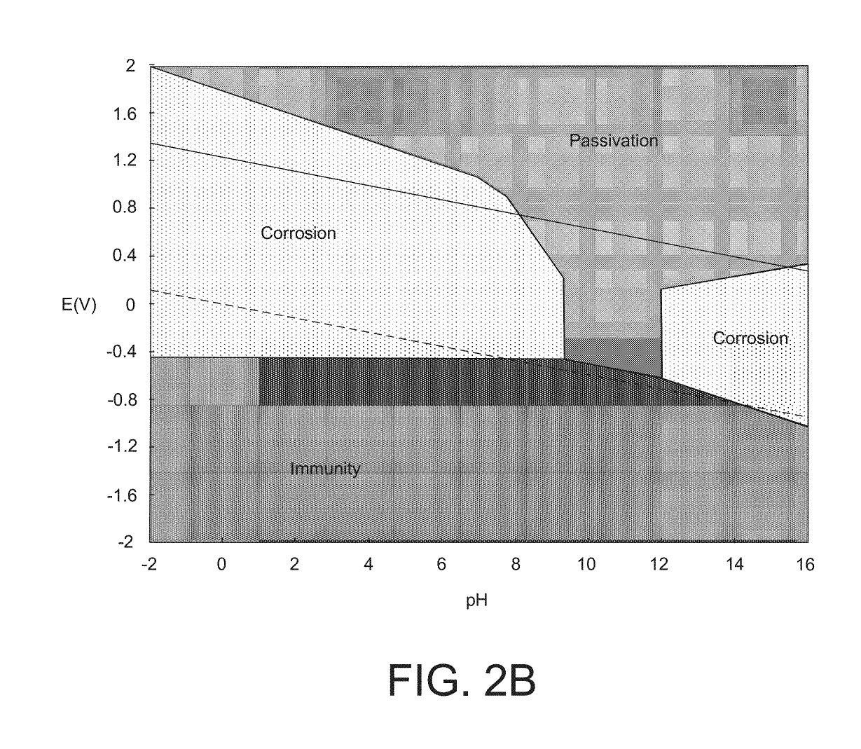

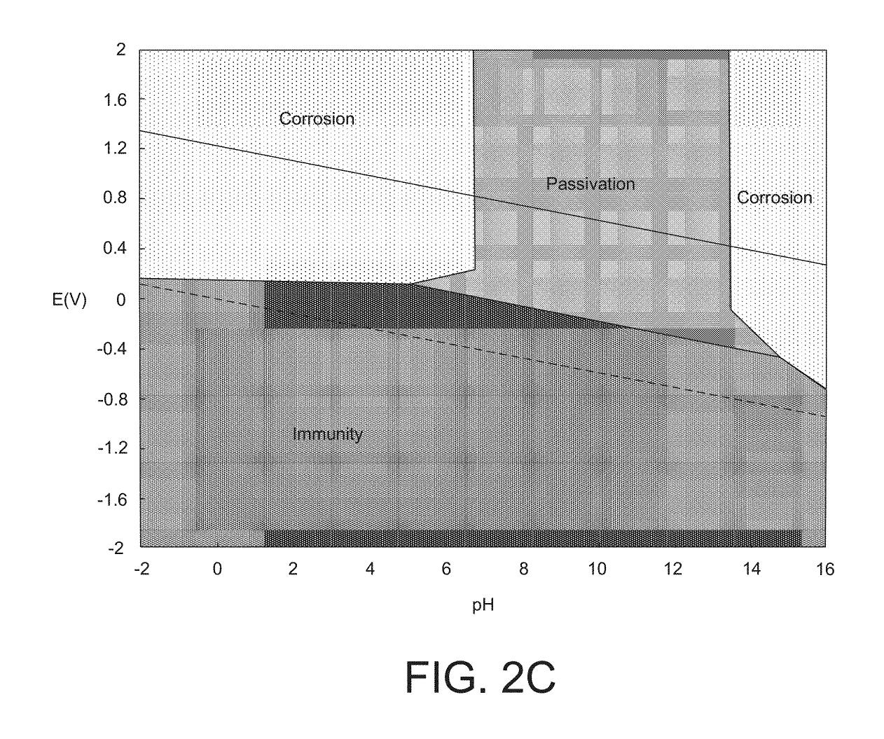

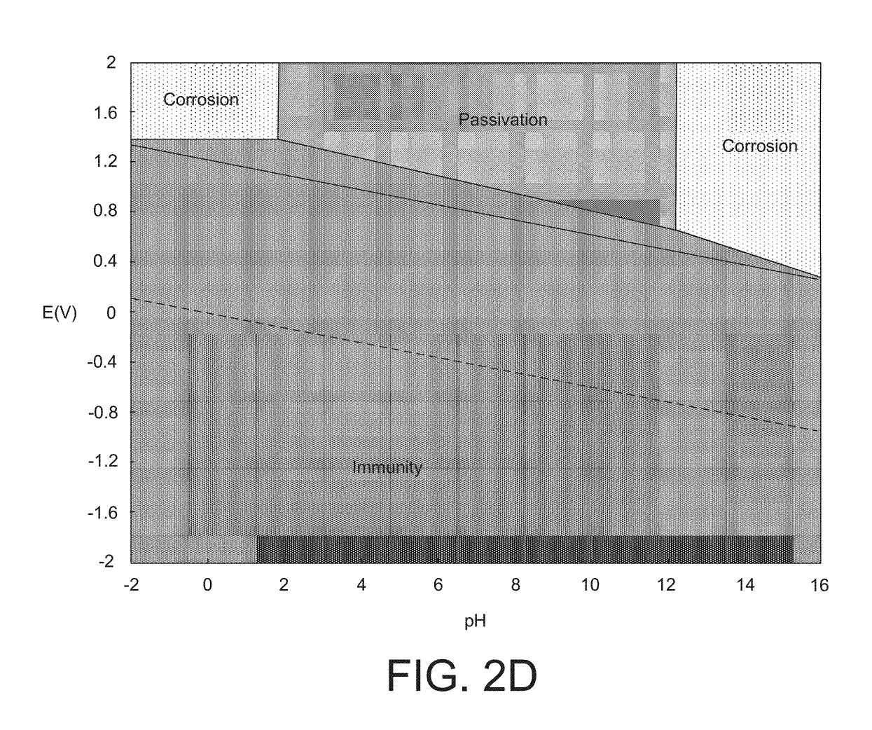

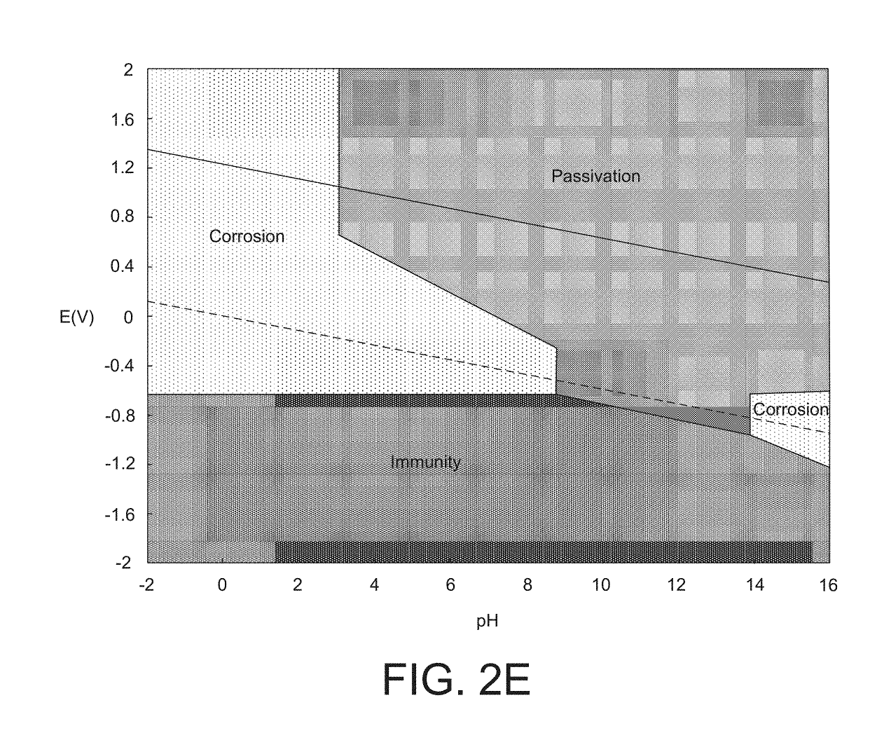

FIGS. 2A through 2E are example diagrams that illustrate regions of stability (immunity), corrosion, and passivation. The diagrams are often referred to as potential/pH or Pourbaix diagrams and can be used to predict corrosion behavior of a material included in the electrical component 110 (shown in FIG. 1). Specifically, FIG. 2A is an example Pourbaix diagram for Aluminum [Al], FIG. 2B is an example Pourbaix diagram for Nickel [Ni], FIG. 2C is an example Pourbaix diagram for Copper [Cu], and FIG. 2D is an example Pourbaix diagram for Gold [Au]. Regions are labeled for immunity, corrosion, and passivation.

In some implementations, when the electrical component 110 is biased at 1 Volt vs. SHE (Standard Hydrogen Electrode) and placed in a fluid (e.g., an aqueous electrolyte (salt water)) with neutral pH≈7, some current carrying metals included in the electrical component 110 will passivate in these conditions, while others may not. For example, nickel (Ni) ions will readily dissolve and do not form a protective layer. Conversely, titanium (Ti) oxides including hydroxide terminated forms of the metal surface will form a passive film that does not easily dissolve. The passive film protects the underlying Ti metal atoms from further reaction. Electrical components should be chosen which have ability to form passive films when possible.

As another example, steel and iron will only begin active-passive transition above neutral pH values when biased>−0.6 V_{SHE} (vs. Standard Hydrogen Electrode) as shown in FIG. 2E. This results in a relatively narrow window for passivation. Also, the passivation potential is lower<−0.6 V. Accordingly, there is a relatively small active-passive region.

A wider range of pH where passivation is possible for [Cu] copper as shown in FIG. 2C. At electrolyte pH from approximately 7-14, the oxide layer will begin to protect the underlying metal at bias>0 Volts. The metal also has a higher passivation potential E_{PP} than, for example, iron [Fe] where metal oxide film formation will begin (≳0 V_{SHE} @ pH≈7). As shown in FIG. 2C, copper has a relatively large immunity to passive transition region spanning between approximately a pH of 5-15. As shown in FIG. 2D, gold [Au] has one of widest ranges of passivation in varying electrolyte pH and also has very high or noble E_{PP}.

The electrical component 110 (shown in FIG. 1) can be configured with the protective layer 120 spanning an applied bias voltage range (e.g., a target applied bias voltage range) to limit corrosion and/or heat generation from reactions. The electrical component 110 can include a metal chosen for an application that has bias voltages in the range of conditions with passivation behavior in an aqueous environment. If the transpassive voltage is exceeded, passivation will break down. Likewise, if the bias voltage is below the passivation potential, corrosion can also proceed in uncontrolled manner.

The electrical component 110 can be configured to operate in an application with an upper voltage bias below a transpassive potential, or a potential at which passivated metal dissolves. The electrical component 110 can be configured to operate in an application with a lower voltage bias that is above a passivation potential.

The transpassive breakdown potential voltage can be a potential where the passivated metal corrosion rates begin to increase again before rapid dissolution of the anode when potential bias becomes too high or positive—the transpassive state. The rate of corrosion can increase exponentially (log function) with voltage (i.e. according to Tafel equation). The transpassive potential where passivation breakdown begins is critically important and should be higher than the bias applied or expected in normal operation of equipment (e.g., a metal included in the electrical device 100). Generally, it is at least a couple of volts higher so that any slight change in conditions will not lead to uncontrolled electrochemical reactions such as corrosion or the breakdown and dissolution of the passivation layer (e.g., the protective layer 120). However, some metals do not go through a passive state or may be suddenly exposed to potentials which force them directly into the transpassive state.

Below the transpassive potential, in the passivation region, the material (e.g., a metal or alloy included in the electrical component 110) experiences very low areal current densities which are often several orders of magnitude less than the corrosion current density (i.e. current per area). The passivation region may extend over a small span of voltage, may extend over a range including larger spans, or may not exist at all. In this passivation region, the protective layer 120 can function as an insulator or semiconductor. When passivation is present, electrical pathways through the electrolyte are limited and electrochemically reactive surfaces are minimized. It also raises the resistance to conductivity, diffusion or transport, and/or charge transfer. The passivation of metal generally raises electrochemical reaction overpotentials often classified as activation, concentration, and resistance contributions. The protective layer 120, which can be a self-protecting layer, can function as a barrier to the underlying conductive materials (metals) of the electrical component 110. It effectively inhibits electrochemical reactions and reduces the overall current. In the case of a battery, for example, this can slow down the discharge of cells in aqueous conditions.

In some implementations, it may also be desirable (e.g., ideal) if the passivation potential is formed at a bias voltage below what is expected in an application of the electrical device 100. This can be referred to as the lower limit of the passivation region or values of operation greater than the Epp or passivation potential. If operating at a voltage bias below the passivation potential, this is the active electrochemical region and should be avoided. Here, corrosion will proceed and could present significant problems. Therefore, the biased voltages applied should be less than the transpassive potential voltage.

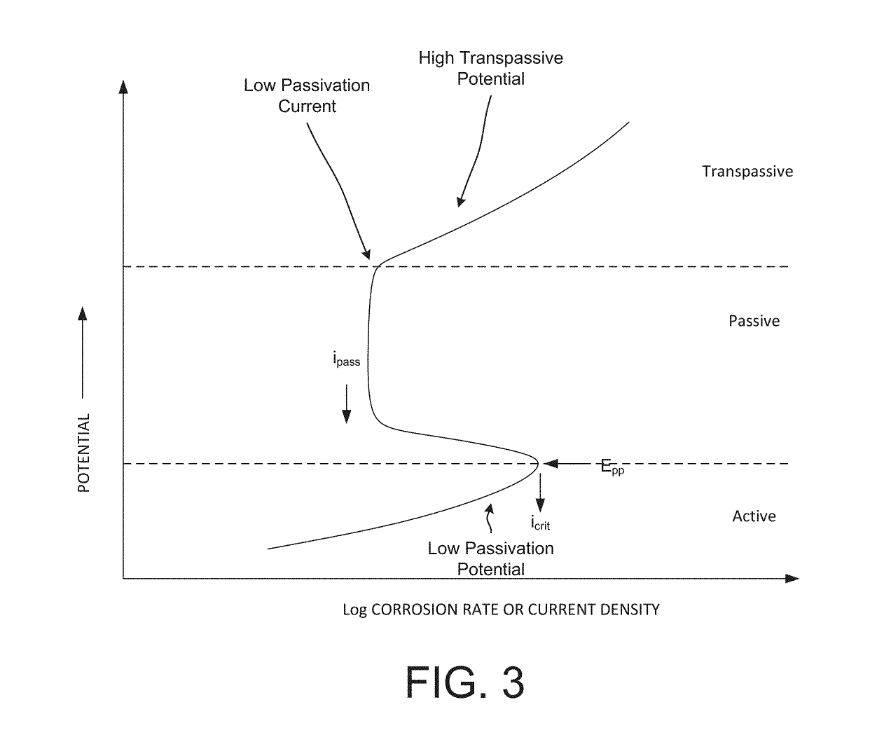

FIG. 3 is a diagram that illustrates potential versus log corrosion rate or current density for a metal that can be included in the electrical component 110. This diagram illustrates an example of a metal that exhibits active-passive behavior. In this implementation, a relatively low passivation current can be desirable. A relatively high transpassive (passivation breakdown) potential can also be desirable. A relatively low passivation potential can also be desirable.

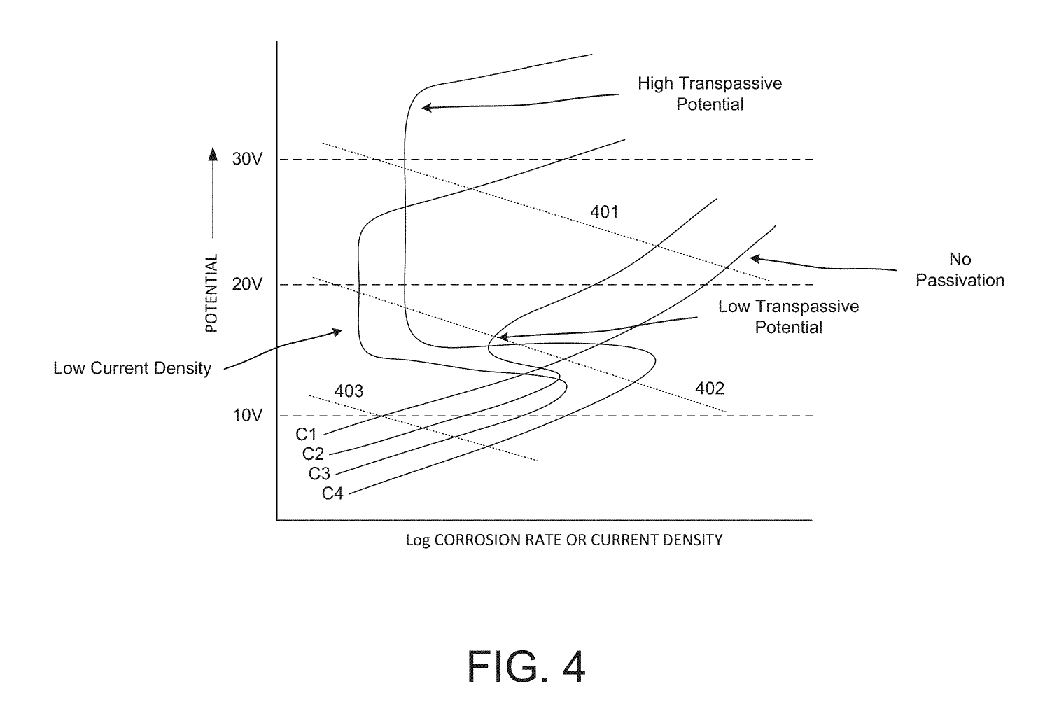

FIG. 4 illustrates four different metals (C1, C2, C3, and C4) that have varying passive behaviors. The electrical component 110 can include one or more of the different metals C1 through C4, which can have a corrosion resistance configured for one or more applications. The formation of the protective layer 120 can be observed under applied bias. As an example, the metals C1 through C4 can be ranked-ordered for each voltage condition (y-axis) from 10, 20, and 30 V applied bias or potential difference. For a 10 V application, the metals can be rank-ordered C1, C2, C3, and C4. For a 20 V application, the metals can be rank-ordered C3, C4, C2, and C1. For a 30 V application, the metals can be rank-ordered C4, C3, C2, and C1.

Lines 401 through 403 represent various conditions for the metals C1 through C4. Line 401 represents a reducing condition (e.g., no oxygen, under water). Line 402 represents a moderately oxidizing condition (e.g., with some oxygen present). Line 403 represents a strongly oxidizing condition (e.g., high oxygen partial pressure).

For example, for conditions represented along line 402, the behaviors of the various metals C1 through C4 are described below. Metal C1 does not have a passivation behavior (which is not ideal for the condition represented by line 402). Metal C2 has a low transpassive potential (which is acceptable for the condition represented by line 402). Metal C3 has the lowest current density along the condition represented by line 402. Metal C4 has the highest transpassive voltage along the condition represented by line 402.

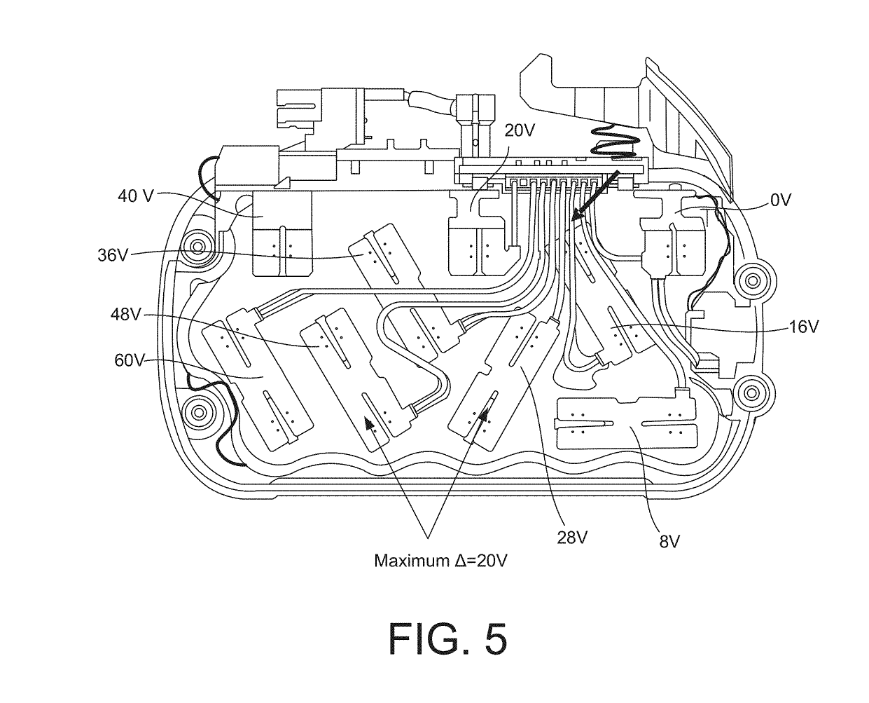

The breakdown limit of the protective layer 120 of the electrical component 110 is determined by the application where metals (materials) are used and will correspond to the target (e.g., expected) bias applied to components from a battery of the electrical device 100. For example in FIG. 5, the breakdown limit is 20V. In this implementation, the high-side or anode (i.e., the 48 V side) will form a protective layer and the low-side or cathode (i.e., the 28 V side) may be relatively unaffected and/or may receive a metal. In the example in FIG. 6, the breakdown limit is 8V. In this implementation, the high-side or anode (i.e., the 12 V side) will form a protective layer and the low-side or cathode (i.e., the 4 V side) may be relatively unaffected and/or may receive a metal.

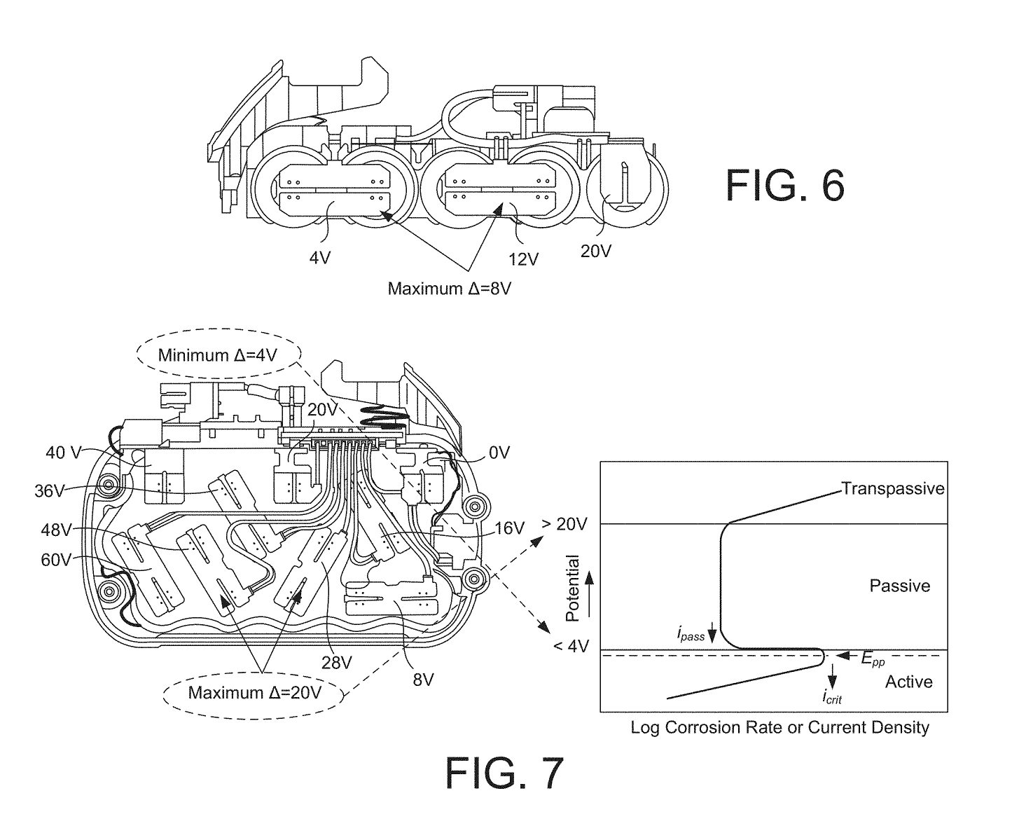

FIG. 7 illustrates the minimum and maximum voltages for an example implementation of a battery pack. The device shown in FIG. 7 can be a 60 V battery pack. The minimum potential difference between adjacent electrical connectors in this example is 4 V and the maximum potential difference between adjacent electrical connectors in this example is 20 V. Therefore, a material that forms a passivation layer at a voltage difference range of at least 4V to 20V should be selected for the electrical connectors. Alternatively, one could select one material that forms a passivation layer at lower potential difference for some of the electrical connectors having a smaller potential difference, and another material that forms a passivation layer at a higher potential difference for other electrical connectors having a larger potential difference.

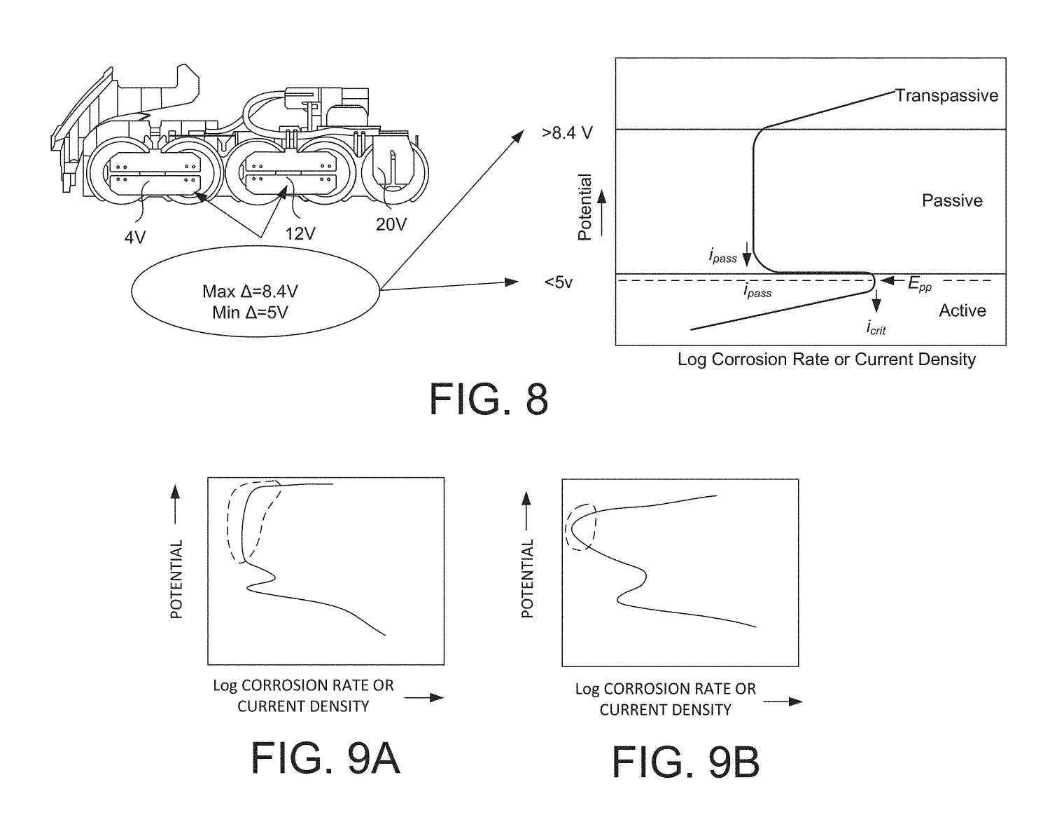

FIG. 8 illustrates the minimum and maximum voltages for an example implementation of a battery pack The device shown in FIG. 8 can be a 20 V battery pack. The minimum potential difference between adjacent electrical connectors in this example is 5 V and the maximum potential difference between adjacent electrical connectors in this example is 8.4 V. In some implementations, nickel plated steel straps can be resistance welded to the battery cells. These can replaced with wire bonding. Therefore, a material that forms a passivation layer at a voltage difference range of at least 5 V to >8.4 V should be selected for the electrical connectors. Alternatively, one could select one material that forms a passivation layer at lower potential difference for some of the electrical connectors having a smaller potential difference, and another material that forms a passivation layer at a higher potential difference for other electrical connectors having a larger potential difference.

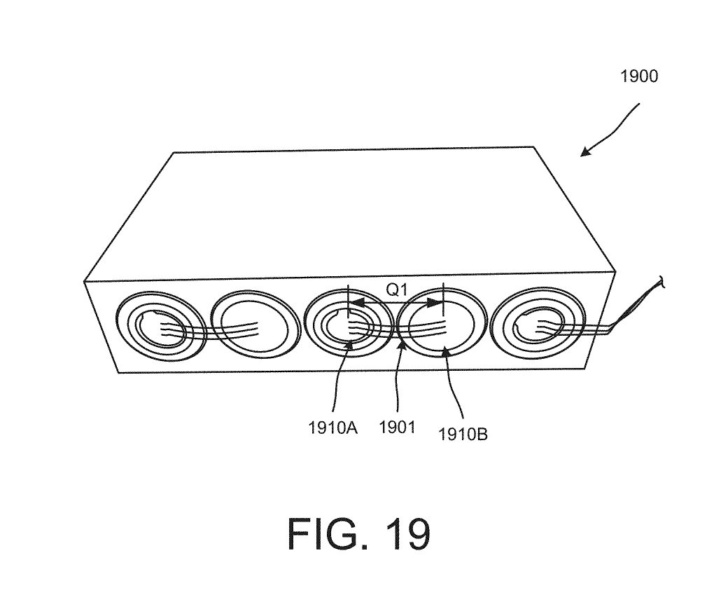

With respect to, for example, battery packs and other (DC) electric power sources, additional measures can be implemented to diminish the electrochemical reactions in addition to, or instead of, metal selection. These can include the control of geometry and/or coatings for electrical components. The applications for the solution to this problem could be especially beneficial to power tools where exposure to outdoor environments is somewhat common for these devices. More details regarding geometry are described in connection with at least, for example, FIG. 19.

FIGS. 9A and 9B are diagrams that illustrate passivation curves for steel under oxidizing conditions. FIG. 9A is a passivation curve for 316 steel. The curve in FIG. 9A illustrates a large passive region (illustrated with a dashed region) with unlikely pitting. FIG. 9B is a passivation curve for 440B steel. The curve in FIG. 9B illustrates a small passive region (illustrated with a dashed region) with likelihood of pitting corrosion. This is further indication that corrosion behavior in same electrolyte is heavily influenced by material or specifically affected by choice of alloy used.

In some implementations, after the protective layer 120 has been formed, the protective layer 120 can be preserved in a desirable fashion. Specifically, the protective layer 120 can be configured to be preserved. For example, when the protective layer 120 has less than ideal volume change characteristics, the protective layer 120 may not provide continued protection. In contrast, when the protective layer 120 has desirable volume change characteristics, the protective layer 120 can protect underlying metal. This trait can be generally stated by saying the protective layer 120 is formed and preserved in relevant condition (V bias, pH, etc.). There may be other extrinsic factors which cause the passive film not to be preserved even though conditions are favorable (e.g. mechanical force like friction or vibration, presence of strong oxidizer or reducer, complexing agent in electrolyte, turbulent water, unique geometry, localized pitting, and so forth). One characteristic that can be used to determine whether or not the protective layer 120 will be preserved in a desirable fashion is the Pilling-Bedworth (P-B) ratio, which is discussed in more detail below.

Metals can be classified into two categories: those that form protective oxides, and those that cannot. The protectiveness of the oxide can be attributed to the volume of the formed oxide in comparison to the volume of the metal used to produce this oxide in a corrosion process in dry air. The oxide layer can be unprotective if the ratio is less than unity because the film that forms on the metal surface is porous and/or cracked. Conversely, the metals with the ratio higher than 1 tend to be protective because they form an effective barrier that prevents the oxidizers from further reaction with the metal since the volume change is close to parity with underlying molecular structure.

P-B ratio can be defined as:

$${R}_{PB} = \frac{{V}_{oxide}}{{V}_{metal}} = \frac{{M}_{oxide} \cdot {ρ}_{metal}}{n \cdot {M}_{metal} \cdot {ρ}_{oxide}}$$

Where:

R_{PB}—Pilling-Bedworth ratio

M—atomic or molecular mass

n—# metal atoms per molecule of the oxide

ρ—density

V—molar volume

The following connection can be shown based on the P-B ratio:
RPB<1: the oxide coating layer does not provide full coverage and is likely not continuous, providing only limited protective effect (e.g., magnesium)
RPB>2: the oxide coating spalls off because compressive strain and over expansion of passivation product, providing limited protective effect (e.g. iron)
1<RPB<2: the oxide coating is passivating and provides a protecting effect against further surface oxidation (e.g., aluminium, titanium, chromium-containing steels).

However, the exceptions to the above P-B ratio rules are numerous due to its generality. Many of the exceptions can be attributed to the mechanism of the oxide growth: the underlying assumption in the P-B ratio is that oxygen needs to diffuse through the oxide layer to the metal surface; in reality, it is often the metal ion that diffuses to the air-oxide interface. This philosophy, however, is specifically applied to dry conditions, not aqueous ones. A similar rationale can be applied to aqueous passivation films with, for example, greater consideration for hydroxide corrosion products.

The diffusion of ions to the anode or sometimes referred to as the anolyte will determine the current response. For aqueous electrochemical reactions, this can be predicted by the Cottrell equation. The Cottrell equation is defined for planar electrodes, but can also be derived for other geometries with corresponding Laplace operator and boundary conditions in conjunction with Fick's 2^{nd} law of diffusion. In practice the constants of this equation can be simplified into one written as i=kt^{-1/2} where i is current density, t is time in seconds, and k is product of aforementioned constants.

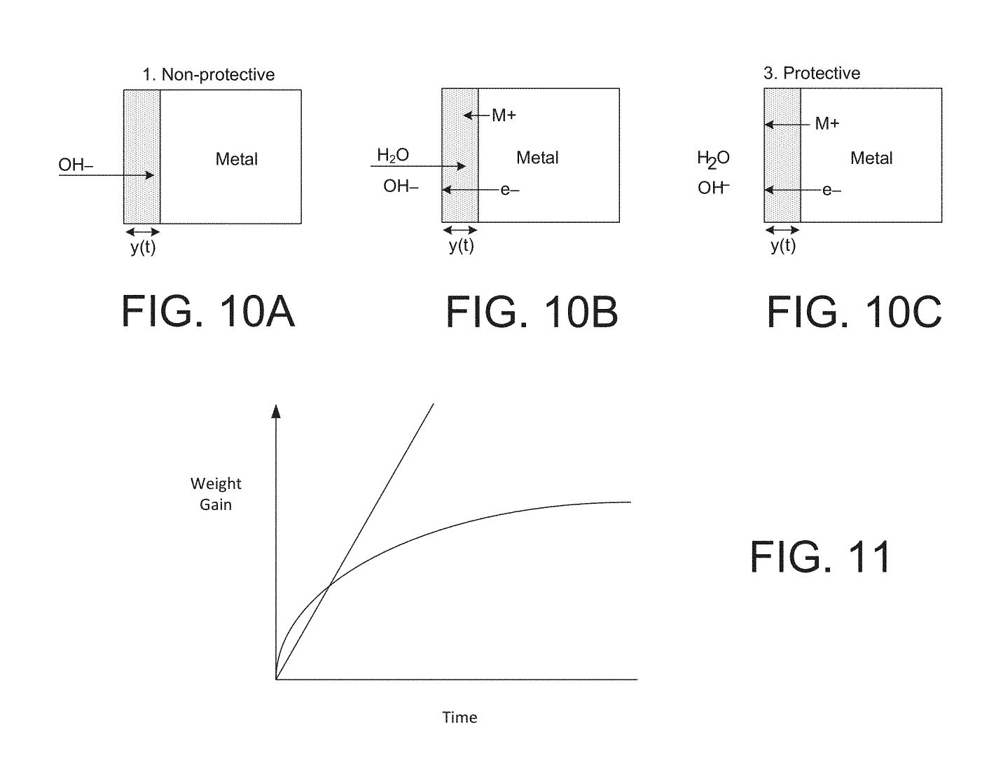

FIGS. 10A through 10C illustrate various examples of protective layer (e.g., oxide layer) growth in aqueous conditions. In protective layers, electrons (e) reach the metal/metal oxide interface, M⁺ ions must diffuse away (out) from interface, and aqueous anions (e.g. OFF) diffuse toward interface.

FIG. 10A illustrates a non-protective layer. As shown in FIG. 10A, a passive film is sufficiently porous to allow anions to diffuse to interface y(t) and grow linearly with time. Large volume changes at the interface continue to expose new metal reaction sites. This inward growth is not ideal for protection

FIGS. 10B and 10C illustrate protective layers. As shown in FIG. 10B, electrons diffuse through film, but both metal ions and anions can diffuse into the passive film to react. Volume changes occur in the passive film. As shown in FIG. 10C, a passive film protects metal from reactive anions by limiting their diffusion, but electrons can still conduct across passive film to oxidize at electrolyte interface. As metals dissolve and pass through film, the volume change occurs at outer interface of passive film with outward growth mechanism. FIG. 10C illustrates this desirable scenario.

Exceptions to the Pilling-Bedworth ratio are often due to the differing growth mechanisms and the location where volume change occurs (such an example of growth over time is illustrated in FIG. 11). The line illustrates growth of a non-protective layer and the curve illustrates growth of a protective layer. This affects the integrity of the passive film and the diffusion through it. Diffusion is controlled by Fick's 1^{st} law and as protective films form, the diffusion path lengthens, resulting in asymptotic growth rate. Conversely, in non-protective film formation the diffusion through aqueous medium is significantly faster and does not limit reaction, resulting in more linear growth. In this case, the passive film or scale often spalls off as the reaction proceeds relatively unhindered.

The electrical component 110 (shown in FIG. 1) can be configured with a low energy of formation for corrosion products and subsequent heat generation as a product of passivation and/or corrosion. Because corrosion can only be limited and it may not be completely stopped under strong bias conditions, even in the passive region, the electrical component 110 can include one or more metals which limit the energy of formation for corrosion products. Accordingly, the energy per mole of product formed and the rate of moles/time can be reduced (e.g., maintained at minimum) in the electrical component 110 so accumulated heat energy does not cause irreversible damage to equipment and pose safety risks.

The Gibbs free energy (e.g., free enthalpy) is a metric which can indicate the maximum amount of energy in a chemical reaction within the electrical component 110. A quantitative measure of the favorability of a given reaction at constant temperature and pressure is the change AG in Gibbs free energy that is (or would be) caused by the reaction where ΔG=ΔH−T·ΔS, the difference between change in enthalpy H and product of temperature T and change in entropy S. In electrochemical reactions, ΔG=−nFE where n is electrons/mole, F is Faraday constant, and E is electrical potential. The value for E is the bias voltage and the driving force for electrochemical reactions. When ΔG for reaction is negative, it is an exergonic reaction or in other words, it will be more likely to react spontaneously or more favorable because there is a large driving force to lower the energy state of reactants. The reaction will proceed toward equilibrium where the ΔG=0. Generally, an exergonic reaction will also be exothermic. This means it will also have a negative ΔH which indicates heat from the reaction will be transferred to the environment. A large negative value for ΔH will have capacity to release more heat upon reaction. Heat energy of formation is associated with the products formed.

The kinetics of the reaction or essentially the reaction rate will determine the quantity of reaction products formed over time within the electrical component 110. This is a second critical factor in determining how much heat will be generated during reaction. Therefore, it is a function of the heat released per mole and the number of moles reacted. Heat will also be lost to the environment during this time, but when heat is quickly generated in confined areas with poor heat transfer, there will be an accumulation of heat energy that will contribute to a rise in temperature and ultimately degradation of materials. This can cause significant problems which could otherwise be avoided with better material selections. Specifically, a corrosion resistant set of metals included in the electrical component 110 that generates less heat from reaction will help address fundamental issues that can lead to degradation or failure.

The Standard Gibbs free energy of formation for metal oxidation products can be represented within an Ellingham diagram (not shown). Such diagrams can be used in prediction of the corrosion product energy per mole in the electrical component 110. For example, the Ellingham diagram specifically depicts the reaction of specific metals to metal oxides. Although, corrosion of metal leads to metal cations as well as multitude of products of oxidized products. For instance, metal complexes like metal hydroxide and oxyhydroxide and other complex metal coordination will result with varying enthalpies during passivation. The sum of energy released should be minimized to generate less heat. This generally refers to reactions which have ΔG closer to 0 J or lowest possible negative value. Note that the Ellingham diagram can illustrate metal oxide products at varying temperature or pressure, not under voltage bias. Prediction of products under bias was previously discussed above on active-passive transition.

In some exceptions, it may be favorable to use metals in the electrical component 110 which have more negative ΔG if they form strong bond with oxygen that leads to stable passivation film. The heat energy generated per mole of metal will depend on the metals used. However, rates of reactions and the rate of corrosion are also an important factor in minimizing heat energy. The kinetics are typically determined by experiment, but like all chemical processes, the kinetics in corrosion obey the Arrhenius relationship:

$$k = {k}_{0} exp ( \frac{- Δ G}{RT} )$$

where R is the gas constant, k is the rate of reaction and k₀ is the rate constant.

The areal current density (rate) of reduction can, or in some cases must, exceed the critical current density for passivation to ensure low corrosion rate in the passive state. The total heat formed from corrosion is a function of the heat generated per mole and the rate of the reaction. The product from the number of moles of corrosion produced and the energy per mole is equal to the heat input. In equation form,

$$Heat IN = \frac{Heat ( J )}{mole} \times \# moles$$

produced. When the reaction occurs rapidly and energy cannot be easily dissipated to the environment during this time or the Heat Energy OUT or lost to its surroundings is minimized, the accumulation of heat energy will result in an increased temperature of the device. If the reaction rate can be slowed down, then the heat generated will have time to be transferred away from the electrical device 100 and Heat Energy OUT is maximized. This can be much safer and more ideal for operation in wet aqueous environments.

Below illustrates an equation for desirable heat generation within the electrical component 110:

$$Δ Heat ( J ) = Heat IN ( J ) - Heat OUT ( J ) if Heat OUT ( J ) \approx 0 , \\ then acceptable Heat IN ( J ) from reaction for tolerable Δ T is defined$$

$$Heat IN ( J ) = Δ T ( K ) * \{ \sum Mass ( g ) * Specfic Heat Capacity ( \frac{J}{Mass ( g ) * ° K} ) \}$$

In some implementations, heat can accumulate especially if localized within the electrical component 110. This type of heat accumulation can drive a corrosion kinetics faster within the electrical component 110 to cause rapid temperature increase of 100. For example, battery cells connected to 110 can be heated to an unacceptable threshold temperature. After a short duration at threshold temperature, they will experience thermal run-away and sometimes catastrophic failure. Below are heat examples related to various devices.

If, for example, a battery pack has a 70° C. (343 K) temperature limit for normal operation before “cut-off” where the pack is disabled and the acceptable limit for cells in the pack is 90° C. (363 K), then a 20 K=ΔT is acceptable change in temperature allowed from saltwater induced heating effects. In this simplified scenario, the battery pack weighs 1000 g and has a specific heat capacity of

$$1 \frac{J}{g * K}$$

and 50 g of salt water with specific heat capacity of

$$4 \frac{J}{g * K}$$

infiltrate the pack and short biased connectors made of steel where electro-chemical reactions occur rapidly and almost no heat (≈0 J) is dissipated from the pack. Therefore, the acceptable added Heat IN from salt water reactions can be found by the following estimations:

$$Heat IN ( J ) = Δ T ( K ) * \{ \sum Mass ( g ) * Specfic Heat Capacity ( \frac{J}{Mass ( g ) * ° K} ) \}$$

$$Heat IN ( J ) = 20 K * \{ ( 1000 g * 1 J \text{/} g \cdot K ) + ( 50 g * 4 J \text{/} g \cdot K ) \} = 24000 J or 24 kJ$$

The allowable heat generation (ΔH) from salt water induced reactions is 24 kJ of heat released. If it is assumed that half or 50% of the heat energy is generated from steel corrosion, then the amount of steel that can be corroded during reaction can be estimated.

| | ΔHf | ΔGf | S° |
|---|---|---|---|
| Name | (kJ/mol) | (kJ/mol) | (J/mol k) |
| Fe(s) | 0 | 0 | 27.2 |
| Fe₂O₃(s) | −822.2 | −741 | 90 |

ΔH_{reaction}=ΔH_{products}−ΔH_{reactants}=−822 kJ/mol

If maximum ΔH=−12 kJ, then 0.0146 moles of product can be formed. If there are 2 moles Fe per Fe₂O₃, then 0.0292 moles Fe can be reacted before reaching 90° C. The molecular weight for Fe is 56 g/mole, so 1.63 g of Fe can be reacted before leading to fire or explosion of, for example, a battery pack. If each strap weighs 0.55 g, then corrosion of just 3 straps could lead to catastrophic failure. This assumes the heat contribution from corrosion product is 50% input, when in practice it may be much less.

If an electrical connector in power tool has a 105° C. (378 K) temperature limit where glass transition occurs and the acceptable operating limit for tool is 55° C. (328 K), then a 50 K=ΔT is acceptable change in temperature allowed from saltwater induced heating effects. In this simplified scenario, the electrical connecter weighs 0.72 g and has a specific heat capacity of

$$1.7 \frac{J}{g * K}$$

and 2.2 g of salt water with specific heat capacity of

$$4 \frac{J}{g * K}$$

infiltrate the connector and short biased metals where electro-chemical reactions occur rapidly and almost no heat≈0 J is dissipated before failure. Therefore, the acceptable added Heat IN from salt water reactions can be found by the following estimates:

$$Heat IN ( J ) = Δ T ( K ) * \{ \sum Mass ( g ) * Specfic Heat Capacity ( \frac{J}{Mass ( g ) * ° K} ) \}$$

$$Heat IN ( J ) = 50 K * \{ ( 0.5 g * 1.7 J \text{/} g \cdot K ) + ( 2.2 g * 4 J \text{/} g \cdot K ) \} = 482.5 J or 0.48 kJ$$

If a cell phone has a 120° C. (393 K) temperature limit where the electronic components may suffer irreversible degradation leading to failure and the acceptable operating limit for the phone is 70° C. (343 K), then 50 K=ΔT is acceptable change in temperature allowed from saltwater induced heating effects in case of water ingress. In this simplified scenario, the phone connecter weighs 80 g and has a specific heat capacity of

$$1 \frac{J}{g * K}$$

and 5 g of salt water with specific heat capacity of

$$4 \frac{J}{g * K}$$

infiltrate the phone and short biased metals where electro-chemical reactions occur rapidly and almost no heat (≈0 J) is dissipated before failure. Therefore, the acceptable Heat IN from salt water reactions can be found by the following estimates:

$$Heat IN ( J ) = Δ T ( K ) * \{ \sum Mass ( g ) * Specfic Heat Capacity ( \frac{J}{Mass ( g ) * ° K} ) \}$$

$$Heat IN ( J ) = 50 K * \{ ( 80 g * 1 J \text{/} g \cdot K ) + ( 5 g * 4 J \text{/} g \cdot K ) \} = 11000 J or 11 kJ$$

The electrical component 110 (shown in FIG. 1) can be configured with an electrolysis reaction inhibitor to limit current contribution to Joule heat generation, raise activation energy for reactions, and minimize formation of combustible and toxic gases. Electrolysis reactions can be driven under strong voltage bias and lead to undesirable products that are both combustible and toxic. The rate of the reactions depends on the metals included in a component. Some are better inhibitors than others with regard to specific electrochemical half reactions. The overall reaction rate is reduced as a result and the current is minimized, leading to less Joule heating effects. These metals, which can be included in the electrical component 110, are known as inhibitors and are effectively the opposite of catalysts.

A reaction will occur much more easily when appropriate catalyst is present because the overall activation energy for the reactions is lower. This is a result of a more favorable pathway for the reaction mechanism on the catalyst. In the case of inhibiting electrolysis, it is better to have a higher activation energy for the reaction (i.e. poor catalyst). Essentially this will raise the energy required for the reaction to proceed. In electrochemical reactions this is often referred to as the overpotential η and is equal to the difference in applied bias potential and the potential or voltage where the reaction will proceed (this can be predicted by the Nernst equation).

Similar to corrosion, thermodynamic and kinetic considerations exist for electrolysis reactions. The kinetic relationships for electrochemical reactions are described by the Butler-Volmer equation. However, at high overpotentials such as those which might be found in the active corrosion region of biased electrical connectors of power tools (e.g., electrical device 100), the equation can often be reduced to Tafel behavior. In short, the kinetics can be related to voltage at overpotentials where the current is a logarithmic function of the exchange current density on the metal (e.g., electrical component 110). A lower exchange current density effectively slows down the reaction rate and limits how much current can flow. The exchange current density is a function of the metal or alloy chosen for electrical connectors. Therefore, the heat energy can be reduced (e.g., minimized) by the metal chosen.

The table below illustrates exchange current density for hydrogen redox reactions in an acid electrolyte. Metals toward the top of chart would be more favorable for inclusion in the electrical component 110 because they can be reaction inhibitors.

| Metal | log₁₀i₀ (A/cm²) |
|---|---|
| Pb, Hg | −13 |
| Zn | −11 |
| Sn, Al, Be | −10 |
| Ni, Ag, Cu, Cd | −7 |
| Fe, Au, Mo | −6 |
| W, Co, Ta | −5 |
| Pd, Rh | −4 |
| Pt | −2 |

### Tafel Equation

$$η = A \times ln ( \frac{i}{{i}_{0}} ) or i = {i}_{0} {e}^{η / A}$$

i is the current density (A/cm²)
i₀ is the exchange current density (A/cm²)
η is the overpotential (E_{Bias}−E_{corrosion} or E_{Bias}−Eₜᵣₐₙₛₚₐₛₛᵢᵥₑ)

### A is the Tafel Slope (V)

where

$$A = \frac{kT}{e α}$$

and k is Boltzmann's constant, T in Kelvin, e is electron charge, and α is the charge transfer coefficient.

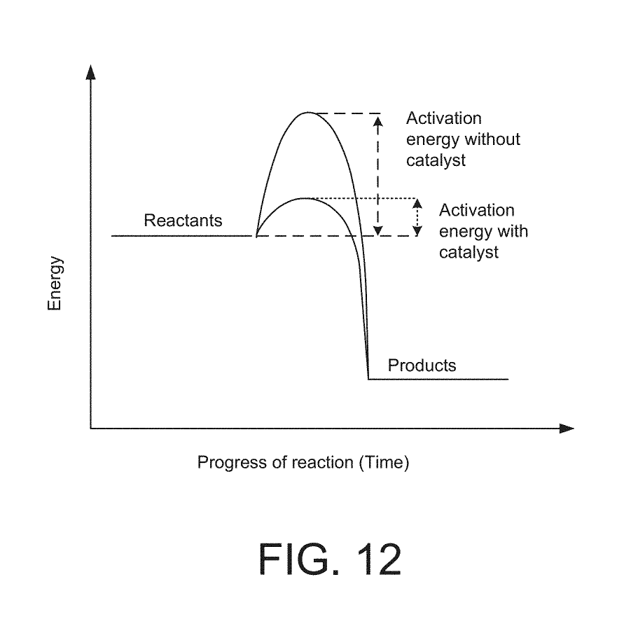

As shown in FIG. 12, a reaction will occur much more easily when appropriate catalyst is present because the overall activation energy for the reactions is lower or the overpotential η is reduced. The overpotential is η=E_{bias}−E_{eq} where E_{eq} is equilibrium potential where no net current flows. This is a thermodynamic principle of catalysis/inhibitors. For example, the forward reaction will not be favored for oxygen evolution on the anode until E>E_{eq}=1.23 V_{SHE} at STP. However, the reaction on platinum, one of the better catalysts for this reaction does not produce measurable currents until ≳1.3 V_{SHE}. In contrast, the activation energy for lead (Pb) is about 0.8 V. In the case of a lead anode, the reaction requires at least 2 V_{SHE} until appreciable current is registered and reaction proceeds. Lead is a better inhibitor than platinum metal for electrolysis.

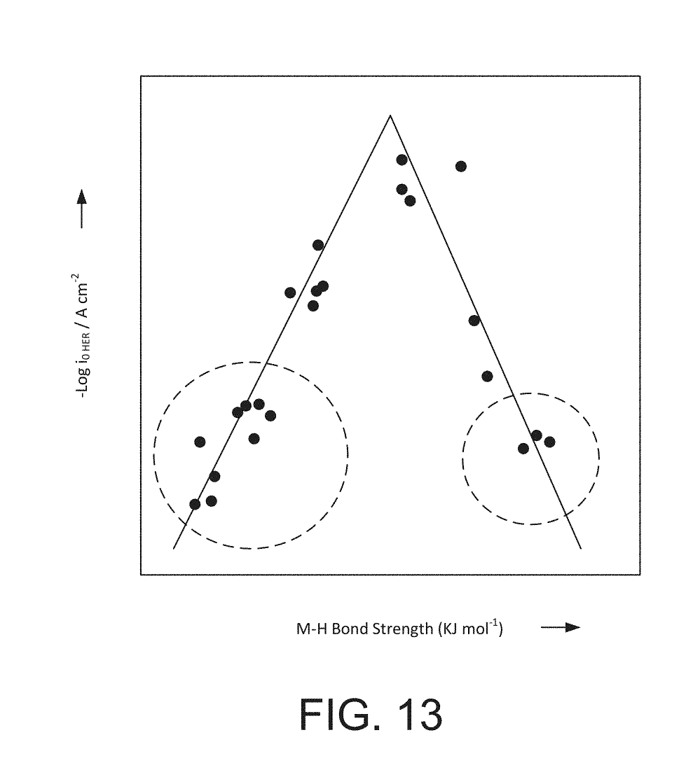

FIG. 13 illustrates metals that can be used for increasing activation energies for electrolysis reactions. A volcano plot (Sabatier principle) for hydrogen evolution reaction (reduction) shows how the current exchange density varies on these metals as a function of metal-hydrogen bond strength. The metals (represented by black dots) included in the circled areas can be included in the electrical component 110 to inhibit electrolysis reactions. Some of the metals can include Cadmium (Cd), Thallium (Tl), Indium (In), Lead (Pb), Zinc (Zn), Gallium (Ga), Tin (Sn), Bismuth (Bi), Silver (Ag), Titanium (Ti), Tantalum (Ta), Niobium (Nb), and so forth.

Catalyst behavior can be predicted in part by the fundamental physical principles of molecular surface interactions. In the case of hydrogen in acidic medium shown in FIG. 13, the strength of the metal bond with hydrogen should not be too strong or too weak. A midpoint defines the peak of the volcano where catalysts have the highest activity towards the half-reaction. For electrochemical hydrogen redox reactions, platinum is the best pure metal catalyst in acid electrolyte. This is one reason why it is used as a standard and a reference electrode for many reactions. In fact, voltage measurements are often defined with reference to 0 V_{SHE} where the equilibrium rate of hydrogen reduction equals the rate of hydrogen oxidation on platinum at STP (standard temperature and pressure) with pH=0.

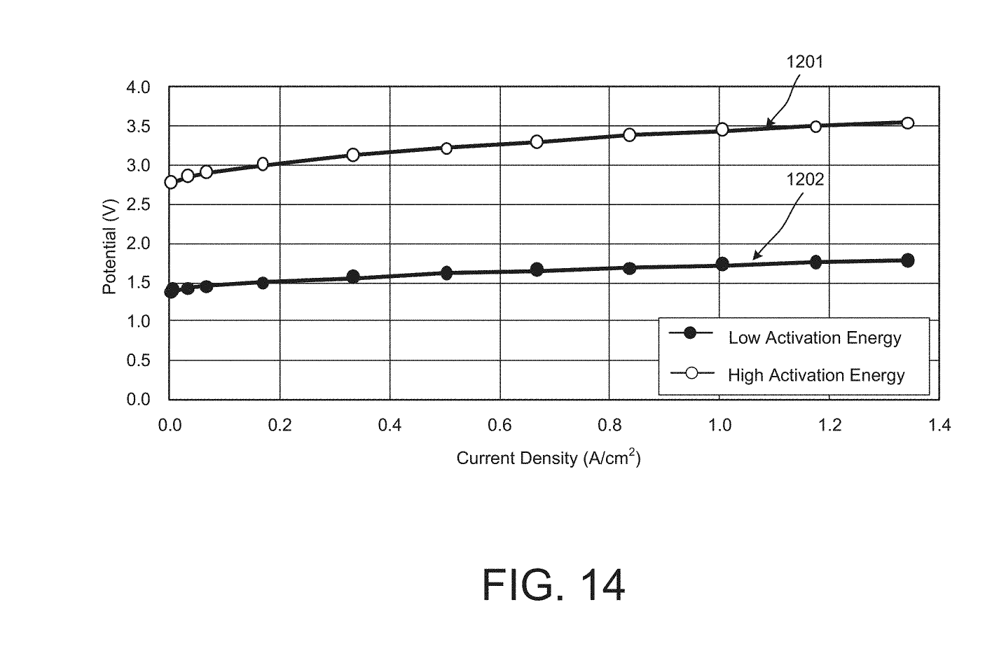

FIG. 14 illustrates a comparison of electrolysis cells. As shown in FIG. 14, potential is shown on the y-axis and current density is shown on the x-axis. In electrolysis cells with equivalent geometric and other extrinsic factors, the performance is determined specifically by the electrode characteristics and the metals used in the electrode will alter the effective reaction rates. A relatively ineffective catalyst is desirable for use in the electrical component 110. As shown in FIG. 14, curve 1201 has a relatively high activation energy required for electrolysis reactions. Also as shown in FIG. 14, curve 1201 represents a material that is an ineffective catalyst for electrolysis reactions, a desirable trait for the electrical component 110. In contrast, curve 1202 represents a material that is a good catalyst for electrolysis reactions, not a desirable trait for the electrical component 110. A much higher voltage is required to achieve the same current density in the material of curve 1201 as compared with the material for the curve 1202. In the case of a biased electrical component, a poor electrochemical catalyst will generate less current, thus less heat.

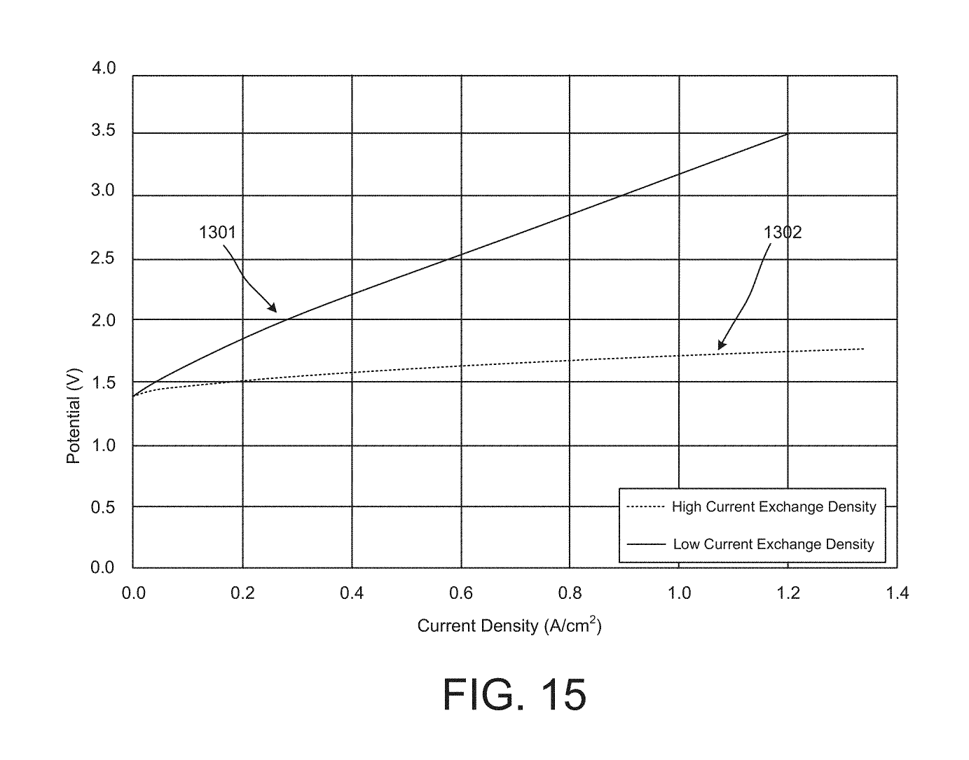

FIG. 15 is another diagram that illustrates a comparison of electrolysis cells. As shown in FIG. 15, potential is shown on the y-axis and current density is shown on the x-axis. As noted with respect to FIG. 14, in electrolysis cells with equivalent geometry, the performance is determined by the electrode characteristics, and the metals used in the electrode will alter the effective reaction rates. In the electrical component 110, reaction inhibitors can be desirable.

As shown in FIG. 15, curve 1301 represents a material that is an inhibitor for electrolysis reactions, but this is a desirable trait for the electrical component 110. As shown in FIG. 15, curve 1302 represents a material that is a good catalyst for electrolysis reactions, but this is not a desirable trait for the electrical component 110. In this particular example, curve 1301 represents a material that has a relatively low exchange current density, which results in a reduced rate of reaction and lower currents at the same bias voltage. In this example, at the same current density, the material represented by curve 1301 has a much higher voltage than the material represented by curve 1302, even though the material represented by curve 1301 has a similar activation energy to the material represented by curve 1302 due to a relatively low i₀ of the material represented by curve 1301.

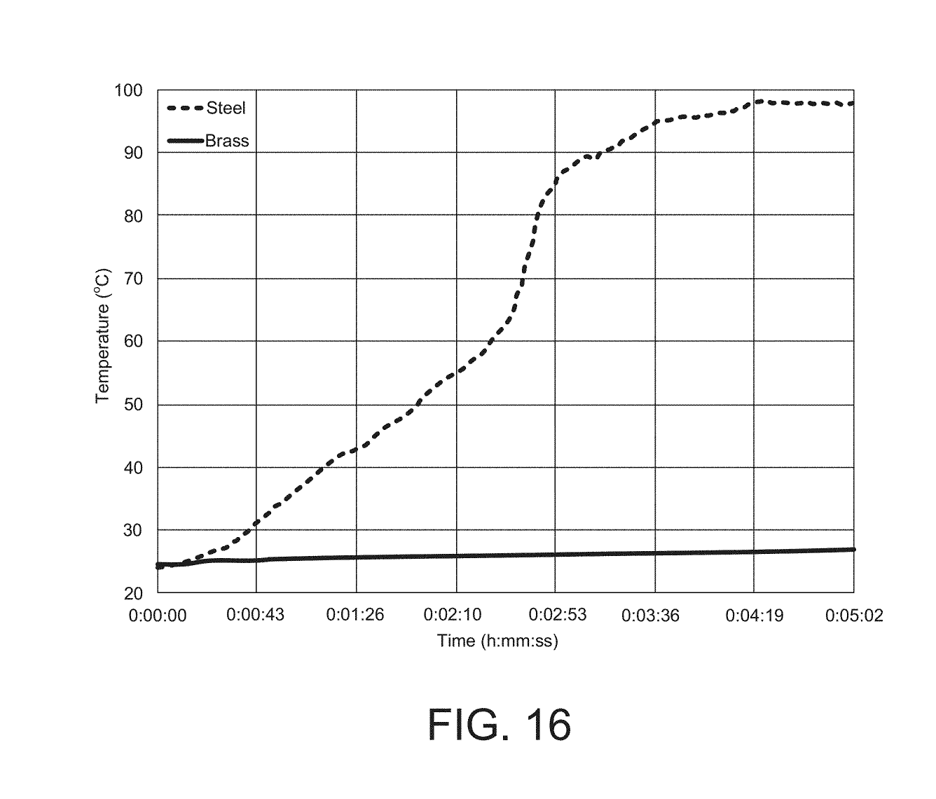

FIG. 16 is a diagram that illustrates the difference in heat generation from 0.6 M salt water exposure between steel and brass at 20 V. As shown in FIG. 16, the heat generated by the brass (2.1° C.=ΔT; approximately 767 J of heat) is approximately 35 times less than the heat generated by steel (73.6° C.=ΔT; approximately 26515 J of heat). This difference in generated heat is unexpected in magnitude. In some implementations, at least one or greater order of magnitude(s) reduction in heat can be generated from, for example, brass, bronze, and/or silver metals compared with standard tin-steel straps. In some implementations, a change in temperature does not exceed a critical threshold temperature change. This threshold temperature change could be the thermal runaway temperature of battery, the melting point of a metal, the glass transition temperature of a plastic, and so forth.

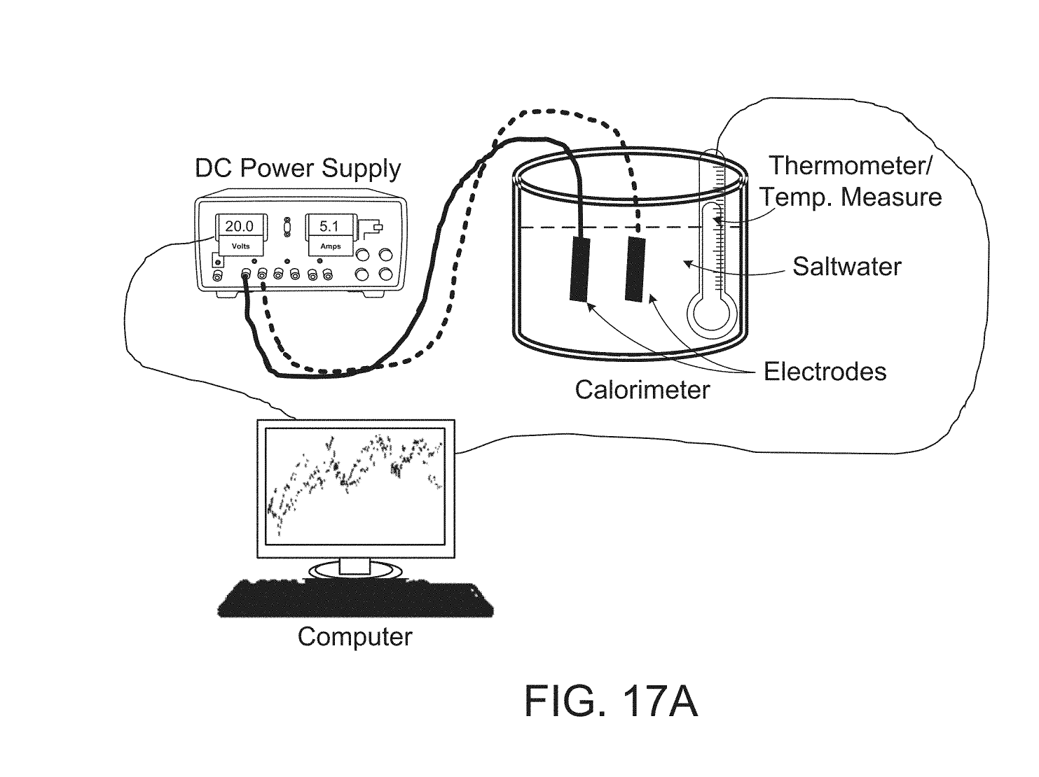

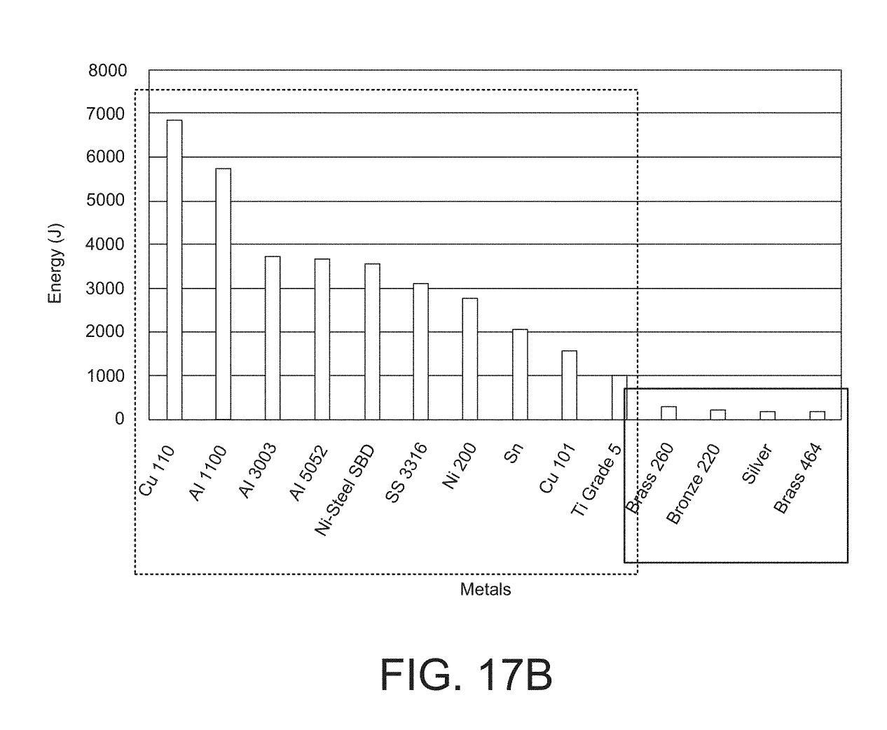

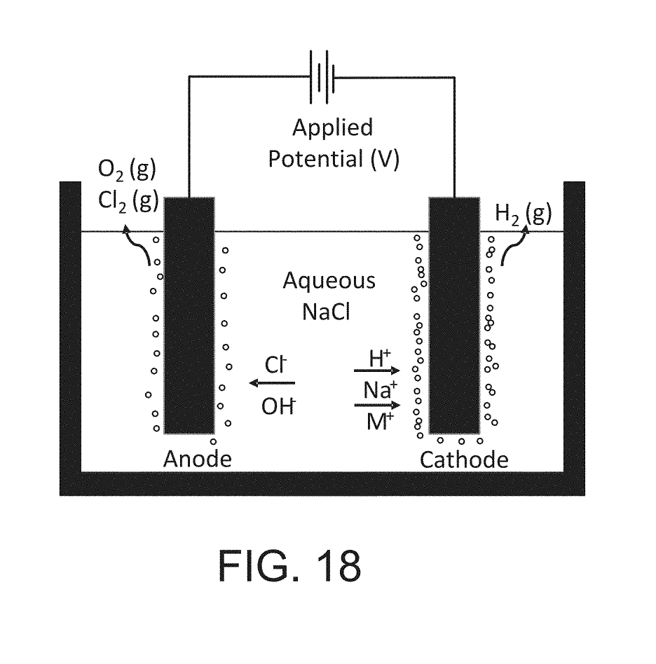

FIG. 17A illustrates an example test system to produce the energy data shown in FIG. 17B. In this example configuration, a voltage difference between the electrodes is held at 20 Volts in a 0.6 M NaCl water solution. A current, in Amperes, and a temperature of the calorimeter is measured for given time. The heat energy can be calculated based on the following formula: E_{1·v·t}+E_{corrosion}≈E_{heat of calorimeter (water+metals)}+E_{heat out (lost to surroundings)}, Simplifying to E_{IN}≈E_{OUT}.

The test configuration shown in FIG. 17A, which is a combination of an electrochemical cell and a calorimeter, can be used to determine the values for energy into and out of a biased set of electrodes. By addition of electric power supply to bias 2 opposing electrodes in electrolyte, a simulated aqueous environment can be established for the electrical connectors in isolation from other contributing factors. From measurement of the current, voltage, and/or resistance of the system over time, the electrical Joule heat energy input (E_{IN}) to the system can be quantified. By integration of the electrochemical test cell into a calorimeter, the heat energy output (E_{OUT}) from the system can also be measured after accounting for changes in temperature and system losses. The difference between measured electrical energy input E_{I·V·t} and E_{OUT} can be used to help determine the heat energy from corrosion (E_{corrosion or} E_{CORR}) products after correcting for calorimeter losses. Materials can be identified with the electrochemical characteristics to enhance safety/reliability in the electrical component 110. In most cases under typical biased voltages, electrochemical reaction impedance is guided by the formation of a stable passivation layer and low current exchange density for half-reactions on the surface of the conducting material. Therefore, its electrochemical behavior can be critical to function under saltwater exposure because control of respective reaction rates will be an important factor in how much heat is generated (i.e. flow of current and heat from corrosion products). The results from this test can be used to infer which materials are most suitable for the application (a long felt need in the industry). The results can be recorded with data acquisition equipment/software to qualify materials.

As shown in FIG. 17B, the metals that are electrochemically resistant generate less heat. Specifically, the metals including brass 260, bronze 220, silver, and brass 464 generate relatively little energy (heat) and can be included in the electrical component 110.

Referring back to FIG. 1, one or more metals included in the electrical component 110, in some implementations, can be selected so that their corrosion resistance in seawater or neutral saltwater is minimized under bias. Under bias of more than a few Volts, most metals will begin to corrode when exposed to aqueous electrolyte. In some conditions, metal surfaces in contact will corrode directly to ions and other soluble species that may or may not precipitate out of the solution. In other conditions, some metals will form a passivation layer on the surface that self-limits the rate at which reactions proceed by limiting diffusion, charge transfer, and conductivity of species to the reactive interfaces. This barrier formation is ideal for corrosion resistance of electrical connectors in saltwater under bias. Though many metals will form a passivation layer, the layer will eventually breakdown as the voltage bias is increased. In order to pass the test for corrosion resistance under saltwater condition, bias should be raised to a value at or above the expected voltage difference on connectors of concern. When the breakdown potential is reached, a sharp increase in current will be observed. If the breakdown potential is exceeded, the material would not qualify for application in the device. For instance, this can be evaluated by potentiodynamic or potentiostatic polarization techniques established in the art with an electrochemical (corrosion) test and/or aforementioned calorimeter test.

As a second defining factor in the electrical component 110, the free energy of formation AG for corrosion products can be maintained at a minimum. Corrosion is an exothermic reaction which forms an oxidation product and releases heat. A choice of metals which releases a minimal amount of heat can be preferred in some implementations. In some implementations, this can be visualized from, for example, an Ellingham diagram. For instance, at 0° C., Copper can release approximately 300 kJ/mol from Cu to Cu₂O while Aluminum can release approximately 1050 kJ/mol from Al to Al₂O₃ (e.g., a 3.5× greater amount of energy per mole than copper).

As an example, in battery terminal connectors, which were exposed to saltwater under 20V bias condition, the brass alloy can be desirable. A stable passivation layer can be formed on the anode (e.g., which can be a light red or green color depending on the alloy). A tin plated metal (e.g., steel) anode may not be desirable due to excessive heat generation. The anode metal can be completely oxidized in just a few minutes.

The electrical component 110 can be, or can include, an electrolysis resistant metal. Electrolysis includes at least two half reactions which occur at each respective electrode. An example electrolysis cell is shown in FIG. 18. The reactions occur above the standard potential at a rate governed by the Tafel equation at high overpotentials; η=A×ln (i/iₒ) where the overpotential (η) is determined by the product of the Tafel slope (A) and the natural log of the current density (i) divided by the current exchange density (iₒ). Different metals possess differing iₒ and A for various reactions that are also affected by the environmental conditions (Temp, electrolyte, pH, oxygen P, etc.). To minimize the current directed towards these specific reactions, metals which minimize the half reaction rates can be selected based on known and/or measured values for them. For instance, zinc metals may be preferred in the cathode to limit hydrogen reduction while another metal that limits oxygen and/or chlorine evolution (e.g., oxidation) may be chosen for the anode. Therefore, selection of metal is also specific to certain electrodes.

Cathode (−) Half Reactions:

Na⁺+e⁻→Na E° red=−2.71 V

2H₂O+2e⁻→H₂+2OH⁻ E° red=−0.83 V

Anode (+) Half Reactions:

2Cl⁻→Cl₂+2e− E° ox=−1.36 V

2H₂O→O₂+4H⁺+4e− E° ox=−1.23 V

Electrolysis Reaction (Applicable)

2NaCl(aq)+2H₂O→2Na⁺(aq)+2OH⁻(aq)+H₂(gas)+Cl₂(gas)

The electrical component 110 can be pre-passivated with the protective layer 120. The protective layer 120 can be a protective chemically-bonded coating. As mentioned above, the electrochemical reactions in saltwater are a function in part of the electrode geometry. Therefore, surface area of the corroding component will be an important factor in the rate of reactions. Minimizing reactive surface area is a key to controlling the electrochemical reactions. To minimize the reactive surfaces, smaller connectors can be used as the electrical component 110 or the non-contact area of the electrical component 110 can be covered with protective coatings such as the protective layer 120. This coating could be of varying chemical nature, but it should serve the function of a high dielectric film that resists breakdown under anticipated bias conditions in saltwater. Examples of this coating could include polymer films, plated metals, or pre-anodized surfaces. Their function is to inhibit corrosion and other electrochemical reactions.

In electrolysis or corrosion, reduction occurs at the lowest potential voltage or cathode. The overall reaction rate is strongly correlated to the cathode surface area. By covering the surfaces of this electrode, it will prevent electrolyte interaction and reduce reaction rates. The coating will also be more apt to maintain its stability in these reactions and thus be more favorable to cover (e.g. with a polymer or dielectric). Conversely, anode coatings will be more likely to be degraded by reactions. This applies to all coating examples listed previously. Therefore, identifying problem points for coating will be beneficial for safety, but also prevent unnecessary use of coatings (to save cost) in areas that are not problematic. Coatings can be processed to selectively coat the non-contact surfaces for electronic connectors.

In some implementations, due to incompatible coatings of electrodes (or metals which will effectively become electrodes in saltwater), there will be a need to coat some existing metals with corrosion and electrolysis resistant metals (e.g., protective layer 120) that are also compatible with connecting materials. Some metals may not be switched due to their inherent properties, cost, or other value. This could require them, To be plated. Electroplating is an example of this technique which can be used to apply electrochemical resistant coating. Furthermore, a metal selected for its low heat generation property may have a high galvanic junction potential (≳150 mV) relative to the connector and lead to galvanic corrosion when exposed to water. Therefore, plating of a compatible metal can serve several functions that minimize its reactivity.

As a specific example, in a battery pack, the casing material or terminals may be made of a metal which under bias is not suitable for a saltwater environment. In this instance, the casing may need to be plated to be suitable for corrosion resistance.

As another specific example, in a battery pack, the terminal material may be made of a metal of which is not suitable for a saltwater environment and the soldered connection is made of a different metal alloy which cannot be changed. They will form a galvanic junction potential when joined in electrolyte. The terminal material can be plated with a corrosion resistant coating that is ≲150 mV difference from the solder to reduce (e.g., minimize) galvanic corrosion.

FIG. 19 is a diagram that illustrates a battery pack that includes wire bonding 1901 between cells (e.g., cells 1910A, 1910B) and separation between the contact points of the cells. The surface area of wire bonding 1901 between the cells 1910A, 1910B shown in FIG. 19 is significantly reduced compared to conventional straps (not shown). In addition, a distance Q1 between the cell connections (e.g., contact points of the wire bonding 1901 on the cells 1910A, 1910B) has been increased by joining at approximately the midpoints of the cells 1910A, 1910B.

Reducing surface area and increasing distance between biased components can slow reaction rates and the resultant heating of battery packs, for example. The electrode area and/or the electrolyte resistance can be contributing factors to, for example, the reactions rates.

In some implementations, a device can include a circuit where an electrical component in the presence of a voltage bias higher than a corrosion voltage of a base material (e.g., base metal) does not exceed breakdown potential. In some implementations, a device can include a circuit where a passivation potential of an electrical component is made of a material (e.g., metal) of stable passivation region that does not exceed breakdown potential.

In some implementations, a device can include a circuit where a voltage bias is present. This circuit can include a material made of a corrosion resistant material (e.g., metal) to saltwater or water with ions dissolved in it.

The device can be a battery comprising a plurality of battery cells and a set of straps, wherein a subset of the straps couple a terminal of a first battery cell to a terminal of a second battery cell, where the straps of the subset of straps are made of a corrosion resistant material with stable passivation to an expected bias potential. The device can be a power tool where the terminals within the power tool are made of a corrosion resistant material up to the bias voltage. The power tool terminal can be made of silver, brass, bronze, or other corrosion resistant copper alloy (such as a brass or bronze).

In some implementations, a battery cell can include a cell housing (e.g., can) and terminals that are made of a material (e.g., metal) exhibiting a higher breakdown potential (versus traditional steel or nickel plated metals). In some implementations, a device can include a circuit where only the anodes (high V) of the corrosion circuit are made with a highly corrosion resistant material. In some implementations, corrosion resistance of the high voltage (anodic) metals of a device can slow discharge of a battery to acceptable and/or safe rates. In some implementations, a device can include one or more materials (e.g., metals) that have free energy of formation (ΔG) for corrosion products that will reduce (or prevent) excess heat during their oxidation, avoiding thermal runaway in, for example, equipment, power tools, or battery packs. In some implementations, a device can be configured where the electrical connectors are designed to minimize corrosion reactive surface area (low area to volume ratio). In some implementations, an electrical connector (e.g., electrical component) can have a relatively low area relative to a volume (3-D) and/or can have a low circumference (e.g., perimeter) relative to an area (2-D).

In some implementations, a device can be configured where the components (e.g., anode and cathode) are placed at greater distance or with a barrier (e.g., an electrolytic path barrier) between them to increase electrolyte diffusion path between biased components and increase an electrolyte resistance.

In some implementations, a device can include a circuit where the electrical components in the presence of a voltage bias higher than the electrolysis potential and are made of a material (e.g., metal) which permits (e.g., only permits) low current exchange density with the reactive surfaces. This can be facilitated by formation of a passivation layer.

In some implementations, a device can include a circuit where a voltage bias is present and the circuit for carrying current is made of an electrolysis resistant material (e.g., metal) to saltwater. In some implementations, a device can be a battery where the straps made of an electrolysis resistant material with stable passivation under the target (e.g., expected) bias potentials. In some implementations, a device can be a power tool where the terminals within the power tool are made of an electrolysis resistant material up to the bias voltage.

In some implementations, a power tool terminal can be made of brass, bronze, or other corrosion resistant copper (or silver) alloy. In some implementations, a battery cell can include a cell can and terminals that are made of a material (e.g., metal) exhibiting a lower exchange current density and Tafel slope (versus traditional steel or nickel plated metals).

In some implementations, a device can include a circuit where the anodes (high voltage) (e.g., only anodes) of the circuit are subject to fluid exposure (e.g., saltwater) and include connector metals made with an electrolysis resistant material. In some implementations, a device can include a circuit where the cathodes (low voltage) (e.g., only cathodes) of the circuit are subject to fluid exposure (e.g., saltwater) and include connector metals made with an electrolysis resistant material. In some implementations, a device can include different metals (materials) where the different metals are used for the anode and cathode.

In some implementations, a device can be configured so that electrolysis impedance of the biased metals will slow the discharge of a battery to acceptable and/or safe rates in saltwater (as compared to conventional steel or nickel selections). In some implementations, a device can include metals that prefer to form electrolysis products which are inherently safer and/or less toxic (e.g. O₂ instead of Cl₂) in nature. In some implementations, a device can include one or more electrical connectors designed to minimize electrolysis reactive surface areas (low area to volume ratio). In some implementations, a device can include one or more electrical components that are spaced at greater distance or with longer electrolyte pathway to increase resistance.

In some implementations, a device can include a protective coating of biased electrical connectors in circuits that can prevent saltwater electrochemical half-reactions. In some implementations, cathode (low voltage coatings) (e.g., only cathode) connections are coated to protect against electrochemical reactions. In some implementations, cathode coatings can be configured to lower the available surface area for electrochemical cathode half-reactions and the overall electrochemical reaction rates.

In some implementations, a coating can be applied to a connector in the circuit where the base metal (material) may not be changed for some pre-determined reason in order to limit electrochemical reactions (electrolysis & corrosion). In some implementations, a coating can be configured to prevent contact of saltwater electrolyte from biased connectors.

In some implementations, a device can include a circuit where the components in the presence of a voltage higher than the base materials corrosion voltage and/or passivation potential are plated with a material of higher corrosion potential and/or passivation potential. In some implementations, a device can include a circuit where a voltage bias is present. This circuit can include current carriers made of a corrosion capable material. The metals are plated by a metal that are more corrosion resistant than the base current carrying material.

In some implementations, a device can be a battery where the straps are plated by a corrosion resistant material (stable passivation). In some implementations, a device can be a power tool where the terminals within the power tool are plated with a corrosion resistant material. In some implementations, a power tool terminal can be plated in brass, bronze, copper alloy, or silver.

In some implementations, a device can include a circuit where the cathodes (e.g., only the cathodes) of the corrosion circuit are plated with an electrochemical reaction resistant material. In some implementations, device can include a circuit where the anodes (e.g., only the anodes) of the corrosion circuit are plated with a high corrosion resistant material.

In some implementations, a battery cell can be configured where the cell is plated by, or including exclusively, a material exhibiting a higher passivation layer breakdown potential versus the base material (e.g. nickel plated steel). For example, in some implementations, a battery can (which can include an anode and a cathode) material can be a metal such as brass (rather than a nickel plated steel material). In some implementations, a battery cell can be plated in brass, bronze, copper-zinc alloy, silver, or similar corrosion resistant metal. In some implementations, a battery cell can be configured so that an external portion of the cell is plated in brass and the internal portion of the cell is plated in nickel.

In some implementations, a battery cell can be configured where the bottom portion (e.g., only the bottom portion) of the cell (negative side) is plated by a low corrosion resistant material. In some implementations, a battery cell can be configured so that the positive cap (e.g., only a positive cap) is plated by a low corrosion resistant material. In some implementations, a battery cell can be configured so that the positive cap and bottom portion of the cell are plated by conductive but electrochemically resistant materials.

The electrical component 110 can include an indicator of corrosion. For example, if the electrical component 110 is made of a brass material and is used as a corrosion resistant battery strap, an indication of corrosion can be found by the formation of a passivation on the high voltage side of the electrical component 110. Brass alloys can turn a color such as green (Brass 230) or red (Brass 464) when they begin to oxidize. In contrast, a steel battery strap will turn black and/or just dissolve. This visual indicator can be an indicator of water contamination, transfer of liability for improper use of equipment, and so forth.

In at least one general aspect, an apparatus can include a first electrical contact point having at a first target voltage potential, and a second electrical contact point having at a second target voltage potential that is different from the first target voltage potential. That apparatus can include an electrical component coupled to at least the first contact point where the electrical component includes an active-passive material configured to form a protective layer in response to a voltage difference between the first target voltage potential and the second voltage target potential while in a fluid in communication with the electrical component and the second contact point. The apparatus can include any combination of the following features.

The fluid functions as an electrolyte. The active-passive material has a passivation voltage range in which the protective layer forms on the electric component at a pH Level of the fluid. The passivation voltage range can span the range of the voltage difference. The active-passive material has a passivation behavior spanning the range of voltage bias, and the passivation range is based on a passivation potential and a transpassive potential. The active-passive material includes a material that inhibits an electrochemical reaction. The active-passive material is a material that inhibits an electrochemical reaction. The first contact point is included in a first cell of a battery and the second contact point is included in a second cell of the battery. The active-passive material is a metallic alloy. The protective layer is chemically bonded to the electrical component. The formation of the protective layer has a low energy of formation with less than a critical (e.g., 10° C.) temperature change in the electrical component. The active-passive material includes at least one of copper-zinc alloy, brass, bronze, or silver.

In another general aspect, a method can include identifying a target bias voltage potential difference between a first electrical contact point and a second electrical contact point included in an electrical device where the target bias voltage potential difference is based on a difference between a first target voltage potential at the first electrical contact point and a second target voltage potential at the second electrical contact point. The method can include selecting an active-passive material having a passivation voltage range spanning the target bias potential range, and configured to be coupled to at least the first contact point and to be in fluid communication with the second contact point. The method can include any combination of the following features.

The selecting is based on the active-passive material being an electrolysis inhibitor. A protective layer forms on the active-passive material at a pH Level of the fluid. The selecting is based on the active-passive material having a low energy of formation of corrosion products.

When an element, such as a layer, a region, or a substrate, is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element or layer, there are no intervening elements or layers present. Although the terms directly on, directly connected to, or directly coupled to may not be used throughout the detailed description, elements that are shown as being directly on, directly connected or directly coupled can be referred to as such. The claims of the application may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. The relative terms above and below can, respectively, include vertically above and vertically below. The term adjacent can include laterally adjacent to or horizontally adjacent to.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A device, comprising:
a housing; and
an electrical component disposed within the housing, at least a portion of the electrical component including an active-passive material, the active-passive material having a passivation range spanning a target bias voltage range of the device.

2. The device of claim 1, further comprising:
an electrolysis reaction inhibitor included in the electrical component.

3. The device of claim 1, wherein the electrical component has a low energy of formation for corrosion products that releases heat less than a threshold value of a component associated with the housing including at least one of a plastic melting point, a flash point, or an electrolyte decomposition temperature.

4. The device of claim 1, wherein the active-passive material is an anode coating configured to decrease an available surface area of a terminal of a battery cell for an electrochemical anode half-reaction.

5. The device of claim 1, wherein the active-passive material has a free energy of formation (ΔG) for a corrosion product that reduces heat during oxidation.

6. The device of claim 1, further comprising:
a protective layer formed on the electrical component.

7. The device of claim 1, further comprising:
a protective layer configured to reduce heat generation within pH range of an aqueous electrolyte.

8. The device of claim 1, wherein the electrical component can include a base current carrying material plated with the active-passive material.

9. The device of claim 1, wherein the electrical component includes a circuit where only an anode of the circuit is made of the active-passive material.

10. The device of claim 1, wherein the device is a battery cell, the active-passive material has a lower exchange current density and Tafel slope than steel or a nickel or tin plated metal.

11. The device of claim 1, wherein the device is a battery cell, the active-passive material is made of a material having a higher breakdown or transpassive potential than steel or a nickel or tin plated metal.

12. The device of claim 1, wherein the active-passive material is a first metal, the electrical component is an anode, the electrical component including a cathode made of a second metal different from the first metal.

13. The device of claim 1, wherein the electrical component includes a circuit where only an anode of the circuit is plated with the active-passive material.

14. The device of claim 1, wherein the active-passive material includes a brass alloy.

15. The device of claim 1, wherein the active-passive material includes a corrosion resistant copper alloy.

16. An apparatus, comprising:
a battery cell including:
a cell housing; and
a conductor coupled to the battery cell and having at least a portion made of a corrosion resistant material with stable passivation to a target bias potential.

17. The apparatus of claim 16, wherein the corrosion resistant material has a passivation range spanning a target bias voltage range of the battery cell.

18. The apparatus of claim 16, wherein the corrosion resistant material is an active-passive material.

19. The apparatus of claim 18, wherein the conductor can include a base current carrying material plated with the active-passive material.

20. An apparatus, comprising:
a battery cell including:
a cell housing; and
a conductor coupled to battery cell and having at least a portion made of an active-passive material, the active-passive material having a passivation range spanning a target bias voltage range of the battery cell.

21. The apparatus of 20, wherein the battery cell is a first battery cell, the conductor is configured to couple a terminal of a first battery cell to a terminal of a second battery cell.

22. The apparatus of 20, wherein the conductor is an electrical terminal, the active-passive material is a corrosion resistant material with stable passivation to the target bias voltage.

23. The apparatus of 20, further comprising:
an electrolytic path barrier.

24. The apparatus of 20, wherein the conductor includes a C50710 material.
